(19) United States
(12) Patent Application Publication
(10) Pub. No.: US 2020/0193550 A1
(43) Pub. Date: Jun. 18, 2020

(54) METHOD AND SYSTEM FOR EVALUATING CATCHMENT AREAS ASSOCIATED WITH A TRANSPORT HUB BY MEANS OF DATA OF A TELECOMMUNICATION NETWORK

(71) Applicant: TELECOM ITALIA S.p.A., Milano (IT)

(72) Inventors: Massimo COLONNA, Torino (IT); Piero LOVISOLO, Torino (IT)

(73) Assignee: TELECOM ITALIA S.p.A., Milano (IT)

(21) Appl. No.: 16/472,424

(22) PCT Filed: Dec. 22, 2016
(86) PCT No.: PCT/EP2016/082346

§ 371 Date: Jun. 21, 2019

(51) Int. Cl. G06Q 50/30; H04W 4/029; H04W 4/42; H04W 24/10; H04W 4/021

(52) U.S. Cl. CPC G06Q 50/30; H04W 4/029; H04W 4/021; H04W 24/10; H04W 4/42

(57) ABSTRACT

A method of evaluating a catchment area of a transport hub covered by a mobile telecommunication network includes defining two or more categories of individuals based on a purpose for which the individuals reach or leave the transport hub, and for each category, defining at least an associated events pattern. The method also includes acquiring event records from the mobile telecommunication network associated with User Equipment. For a User Equipment, the method searches the event records related to the User Equipment to identify events matching an events pattern associated with a category, matches the owner of the User Equipment with the corresponding category, searches the event records to identify at least one prevalence zone visited by the owner of the User Equipment, and evaluates the at least one catchment area based on the category and on the prevalence zone identified for each User Equipment of the pool.

### BACKGROUND OF THE INVENTION

### Field of the Invention

The solution according to embodiments of the present invention refers to methods and systems implementing data analysis. In detail, the solution according to embodiments of the present invention relates to methods and systems for analyzing movements of people in a predetermined area. In more detail, the solution according to the present invention relates to a method and a system for evaluating one or more catchment areas (i.e., an area from which a city, an institution, or a business company attracts people that live, work, or use services provided by such institution and/or business company) associated with a transport hub (e.g., an airport, a railway station, a bus station, an underground station, etc.) by means of data of a telecommunication network.

### Overview of the Related Art

Travels have a central role in human activities either considering business (e.g., trade) and private (e.g., tourism) activities. Indeed, modern travel vehicles and transports management allow reaching far locations in a reduced time, which is an important feature, for example, in a globalized market where employees, assets and customers of business/manufacturing companies are spread worldwide. Similarly, fast and relatively cheap transportation means allow people reaching even remote locations for tourism.

Therefore, operation efficiency of transport hubs has a substantial weight in determining an effectiveness of human activities (e.g., trade, tourism, etc.) in geographic regions where transport hubs are located and, also, in geographic regions reachable through such transport hubs.

Accordingly, a proper management of a generic transport hub—i.e. the management of the transport hub infrastructures, services and personnel—is fundamental for ensuring the required operation efficiency.

For an effective management of a transport hub, and for correctly sizing transport hub infrastructures and services provided within the geographic area where the transport hub is placed, an in-depth knowledge of one or more catchment areas from which the transport hub attracts people that uses its services is required.

Moreover, the knowledge of the purposes that lead people to the transport hub area may be particularly useful in improving the management of the transport hub.

Generally, transport companies possess data comprising exhaustive lists of freights and/or passengers for each transportation vehicle (e.g., aircraft, truck, train, bus, ship, etc.) departing and arriving at the transport hub, but such data are kept confidential and not shared for passengers/customers privacy and competition reasons. Therefore, such data cannot be exploited for evaluating catchment areas and improving the transport hub management.

Nevertheless, the data available to transport companies do not account for people that may be found at the transport hub, but are not meant to take a flight, a train, a bus, a ship, such as for example (taxi) drivers, non-travelling partners of people that depart or arrive, personnel of the transport hub, etc.

In the art, several expedients have been proposed for analyzing people mobility behaviors.

For example, F. Manfredini, P. Pucci, P. Secchi, P. Tagliolato, S. Vantini, V. Vitelli, “Treelet decomposition of mobile phone data for deriving city usage and mobility pattern in the Milan urban region”, MOX-Report No. 25/2052, MOX, Department of Mathematics “F. Brioschi”, Politecnico di Milano, available at http://mox.polimi.it, discloses a geo-statistical unsupervised learning technique aimed at identifying useful information on hidden patterns of mobile phone use. These hidden patterns regard different usages of the city in time and in space which are related to individual mobility, outlining the potential of this technology for the urban planning community. The methodology allows obtaining a reference basis that reports the specific effect of some activities on the Erlang data recorded and a set of maps showing the contribution of each activity to the local Erlang signal. Results being significant for explaining specific mobility and city usages patterns (commuting, nightly activities, distribution of residences, non-systematic mobility) have been selected and their significance and their interpretation from a urban analysis and planning perspective at the Milan urban region scale has been tested.

B. Furletti, L. Gabrielli, C. Renso and S. Rinzivillo, “Analysis of GSM calls data for understanding user mobility behavior”, 2013 IEEE International Conference on Big Data, Silicon Valley, Calif., 6-9 Oct. 2013, pp. 550-555, discloses that GSM calls data stored by the telecommunication operator in large volumes and with strict privacy constraints may be exploited for mobility behavior identification based on aggregated calling profiles of mobile phone users. The compact representation of user call profiles is the input of a mining algorithm for automatically classifying various kinds of mobility behavior. Having defined the call profiles allows basing an analysis phase on summarized privacy-preserving representation of the original data. These call profiles permit to design a two step process—implemented into a system—based on a bootstrap phase and a running phase for classifying users into behavior categories. The system has been tested in two case studies where individuals are classified into residents, commuters and visitors.

US 2015/0149087 discloses methods, systems, and apparatus, including computer programs encoded on computer storage media, for determining travel information. One of the methods includes obtaining flight information for each of a plurality of users, the flight having a flight identifier and associated with a particular scheduled departure time and departure location; based on the scheduled departure time, obtaining location information for user devices associated with each user of the plurality of users; determining that the respective user devices associated with a first group of users of the plurality of users, has a location associated with the departure location; determining that the respective mobile devices associated with users of the first group are no longer in communication with a mobile network; and using the respective times at which the user devices are determined to no longer be in communication with the mobile network along with the scheduled departure time to determine a departure time.

WO 2015/018445 from the same Applicant discloses a method for managing data regarding one or more flows of physical entities in a geographic area during at least one predetermined time period. For each physical entity, the data comprise a plurality of positioning data representing detected positions of the element in said geographic area and corresponding time data identifying instants at which each position is detected. The geographic area is divided into at least two zones. The at least one time period is divided into one or more time slots. An Origin-Destination matrix is computed for each time slot, each Origin-Destination matrix comprising a respective row for each one of the at least two zones where the flow of the physical entities may have started and a respective column for each one of the at least two zones where the flow of the physical entities may have ended. The geographic area is then subdivided into a plurality of basic zones. A basic Origin-Destination matrix is then computed for the basis zones and time slots. The step of identifying a number of elements flowed from a first zone to a second zone during each time slot comprises combining together a selected subset of basic Origin-Destination matrices for each Origin-Destination matrix, and combining together selected subsets of entries in each combined subset of basic Origin-Destination matrices, or combining together selected subsets of entries in each basic Origin-Destination matrix, and combining together a selected subset of basic Origin-Destination matrices having combined selected subsets of entries for each Origin-Destination matrix.

### SUMMARY OF THE INVENTION

The Applicant has perceived that the known solutions provide unsatisfactory results, as they are not able to determine purposes that brought each individual to the transport hub.

Accordingly, the prior art generally lacks of methods and systems arranged for counting of people within the area of a transport hub and dividing such people into categories, according to a purpose of their presence at the transport hub.

The Applicant has observed that, generally, the expedients known in the art are not able to provide an analysis of catchment areas from/to which people that happen to be within a transport hub area during a predetermined observation time period, move. Moreover, the known expedients are not able to differentiate among categories of people that are identified within the transport hub area. Similarly, the known expedients are not able to identify catchment areas subdivided by categories of individuals.

The Applicant has therefore tackled the problem of how to associate each individual that reaches or leaves the transport hub to a respective category according to a purpose thereof. The Applicant has found that it is possible to identify such purposes by analyzing movements of the individuals. Preferably, the Applicant has found that movements within an area of people belonging to a same category have similar patterns and, therefore, it is possible to associate an individual to a particular category whether a corresponding pattern has been recognized in the movements of the individual.

The Applicant has further found that it is possible to exploit information regarding activities of user equipment possessed/used by individuals and available at a mobile telecommunication network in order to track individuals' movements and identify patterns as mentioned above, in an automated and reliable manner.

This allows automatically evaluating one or more catchment areas for different categories of individuals that interact with the transport hub during the observation time period.

Particularly, one aspect of the present invention proposes a method of evaluating at least one catchment area of a transport hub. Said transport hub is comprised in a hub area which is covered by a mobile telecommunication network having a plurality of communication stations each of which is adapted to manage communications of User Equipment owned/to be used by individuals in one or more respective served areas comprised in at least one geographic area over which the mobile telecommunication network provides services. The mobile telecommunication network is configured for storing event records each one indicating at least a time instant and a position of each event of interaction between a User Equipment and a communication station of the mobile telecommunication network. The method comprises defining two or more categories of individuals based on a purpose for which the individuals reach or leave the transport hub; for each category, defining at least an associated events pattern, the events pattern being a sequence of events of interaction between a User Equipment and a communication station of the mobile telecommunication network; subdividing the at least one geographic area into at least two zones; acquiring event records from the mobile telecommunication network associated with User Equipment. Moreover, for a User Equipment of a pool of User Equipment the method comprises searching the event records related to said User Equipment for identifying a sequence of events matching an events pattern associated with a category; upon finding a match, associating the owner of the User Equipment with the corresponding category; searching the event records related to said User Equipment for identifying at least one prevalence zone of the at least two zones prevalently visited by the owner of the User Equipment. The method further evaluates the at least one catchment area based on the category and on the prevalence zone identified for each User Equipment of the pool.

Preferred features of the present invention are set in the dependent claims.

In one embodiment of the present invention, searching the event records related to said User Equipment for identifying a sequence of events matching an events pattern associated with a category comprises searching event records indicating a respective time instant comprised within a predetermined observation period. Preferably, searching the event records related to said User Equipment for identifying at least one prevalence zone of the at least two zones prevalently visited by the owner of the User Equipment comprises searching the event records recorded during a time period preceding and/or following the observation time period.

In one embodiment of the present invention, the time period preceding and/or following the observation time period comprise a plurality of time windows.

In one embodiment of the present invention, searching the event records related to said User Equipment for identifying at least one prevalence zone of the at least two zones of the at least one geographic area prevalently visited by the owner of the User Equipment further comprises identifying as the prevalence zone a zone of the at least two zones associated with the greatest number of event records indicating a position comprised within said zone.

In one embodiment of the present invention, searching the event records related to said User Equipment for identifying at least one prevalence zone of the at least two zones of the at least one geographic area prevalently visited by the owner of the User Equipment further comprises identifying as the prevalence zone each zone of the at least two zones associated with at least one predetermined threshold number of event records indicating a position comprised within said zone.

In one embodiment of the present invention, evaluating the at least one catchment area based on the category and on the prevalence zone identified for each User Equipment of the pool comprises identifying as the catchment area the zone of the at least two zones which is identified as the prevalence zone for the greatest number of owners of User Equipment.

In one embodiment of the present invention, evaluating the at least one catchment area based on the category and on the prevalence zone identified for each User Equipment of the pool comprises identifying as the catchment area each zone of the at least two zones which is identified as the prevalence zone for a number of owners of User Equipment equal to, or greater than, a predetermined catchment threshold number of owners of User Equipment.

In one embodiment of the present invention, evaluating the at least one catchment area based on the category and on the prevalence zone identified for each User Equipment of the pool comprises identifying a respective catchment area for each category associated with at least one owner of the User Equipment of the pool of User Equipment.

In one embodiment of the present invention, evaluating the at least one catchment area based on the category and on the prevalence zone identified for each User Equipment of the pool further comprises identifying an origin catchment area based on the prevalence zone identified by searching event records recorded during the time period preceding the observation time period, the origin catchment area indicating an area from which owners of User Equipment reach the transport hub.

In one embodiment of the present invention, evaluating the at least one catchment area based on the category and on the prevalence zone identified for each User Equipment of the pool further comprises identifying a destination catchment area based on the prevalence zone identified by searching event records recorded during the time period following the observation time period, the destination catchment indicating an area towards which owners of User Equipment leave the transport hub.

In one embodiment of the present invention, the method further comprises for a User Equipment of a pool of User Equipment searching the event records related to said User Equipment for identifying a sequence of events matching an events pattern associated with a category during the time period preceding and/or the time period following the observation time period; upon finding a match, associating the owner of the User Equipment with a further corresponding category; comparing the category and the further category associated with the owner of the User Equipment, and assessing whether the category associated with the owner of the User Equipment has to be changed based on such comparing.

In one embodiment of the present invention, defining two or more categories of individuals based on a purpose for which the individuals reach or leave the transport hub comprises defining at least one among:
a category (A) of departing individuals, departing individuals leaving the hub area;
a category (B) of arriving individuals, arriving individuals reaching the hub area;
a category (C) of outgoing commuting individuals, outgoing commuting individuals leaving the hub area and then returning back to the hub area, and
a category (D) of incoming commuting individuals, incoming commuting individuals reaching the hub area and then leaving the hub area.

In one embodiment of the present invention, assessing whether the category associated with the owner of the User Equipment has to be changed based on such comparing comprises, if the category associated with the owner of the User Equipment corresponds to the category of departing individuals during the observation time period, and the further category associated with the owner of the User Equipment corresponds to the category of arriving individuals during the time period following the observation time period, changing the category associated with the owner of the User Equipment to the category of outgoing commuting individuals. Alternatively, assessing whether the category associated with the owner of the User Equipment has to be changed based on such comparing comprises, if the category associated with the owner of the User Equipment corresponds to the category of departing individuals during the observation time period, and the further category associated with the owner of the User Equipment corresponds to the category of arriving individuals during the time period preceding the observation time period, changing the category associated with the owner of the User Equipment to the category of incoming commuting individuals. Further alternatively assessing whether the category associated with the owner of the User Equipment has to be changed based on such comparing comprises, if the category associated with the owner of the User Equipment corresponds to the category of arriving individuals during the observation time period, and the further category associated with the owner of the User Equipment corresponds to the category of departing individuals during the time period preceding the observation time period, changing the category associated with the owner of the User Equipment to the category of incoming commuting individuals. Yet alternatively, assessing whether the category associated with the owner of the User Equipment has to be changed based on such comparing comprises, if the category associated with the owner of the User Equipment corresponds to the category of arriving individuals during the observation time period, and the further category associated with the owner of the User Equipment corresponds to the category of departing individuals during the time period following the observation time period, changing the category associated with the owner of the User Equipment to the category of outgoing commuting individuals.

In one embodiment of the present invention, the method further comprises defining a selected portion of the geographic area other than the hub area as a point of interest. Preferably evaluating the at least one catchment area based on the category and on the prevalence zone identified for each User Equipment of the pool comprises identifying whether the at least one prevalence zone comprises the point of interest.

Another aspect of the present invention proposes a system coupled with a mobile telecommunication network for evaluating at least one catchment area of a transport hub. The system comprises a computation engine adapted to process data retrieved from the mobile telecommunication network; a repository adapted to store data regarding interactions between a User Equipment and the mobile telecommunication network, computation results generated by the computation engine and, possibly, any processing data generated by and/or provided to the system; an administrator interface operable for modifying parameters and/or algorithms used by the computation engine and/or accessing data stored in the repository, and a memory element storing a software program product configured for implementing the method of above.

### BRIEF DESCRIPTION OF THE DRAWINGS

These and other features and advantages of the solution according to the present invention will be better understood by reading the following detailed description of an embodiment thereof, provided merely by way of non-limitative example, to be read in conjunction with the attached drawings, wherein:

FIG. 1 is a schematic representation of a system for evaluating catchment areas associated with a transport hub according to an embodiment of the invention;

FIG. 2 is a schematic representation of a surveyed area within which a transport hub area is located;

FIG. 3 is a schematic representation of a Region of Interest in which catchment areas are searched;

FIG. 4 is a schematic representation of an Origin Catchment Area matrix according to an embodiment of the invention;

FIG. 5 is a schematic representation of a Destination Catchment Area matrix according to an embodiment of the invention;

FIG. 6 is a schematic representation of a set of Origin Catchment Area matrices, each associated with a respective considered category of individuals;

FIG. 7 is a schematic representation of a set of Destination Catchment Area matrices, each associated with a respective considered category of individuals;

FIGS. 8A and 8B are a schematic flowchart of a procedure for counting and classifying people within a transport hub according to an embodiment of the invention, and

FIGS. 9A and 9B are a schematic flowchart of a procedure for counting and classifying people within a transport hub according to an alternative embodiment of the invention.

### DETAILED DESCRIPTION OF THE INVENTION

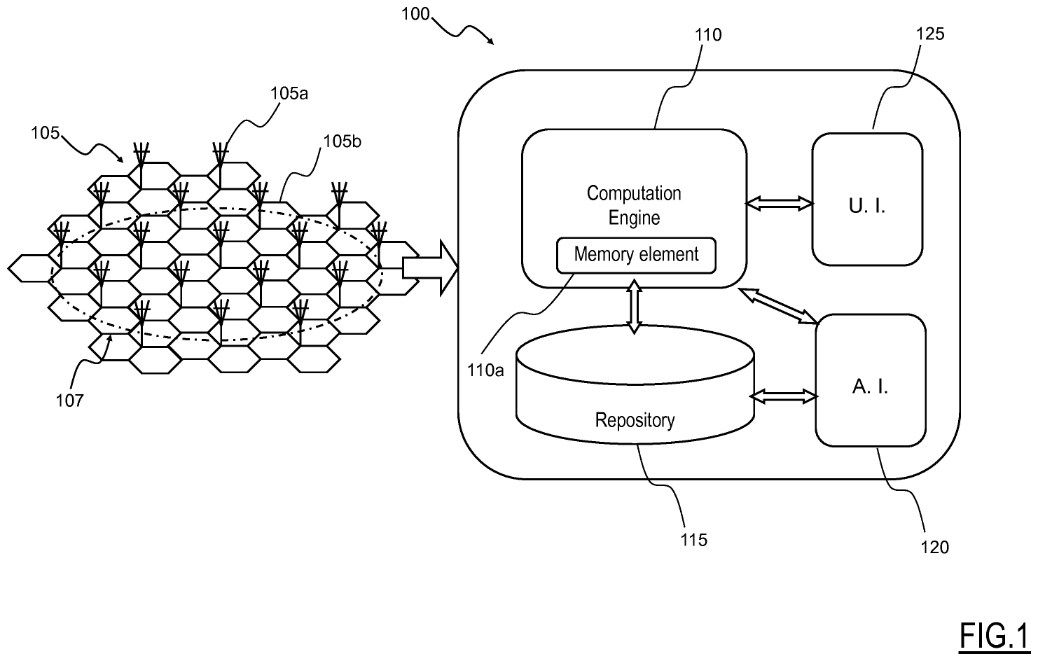

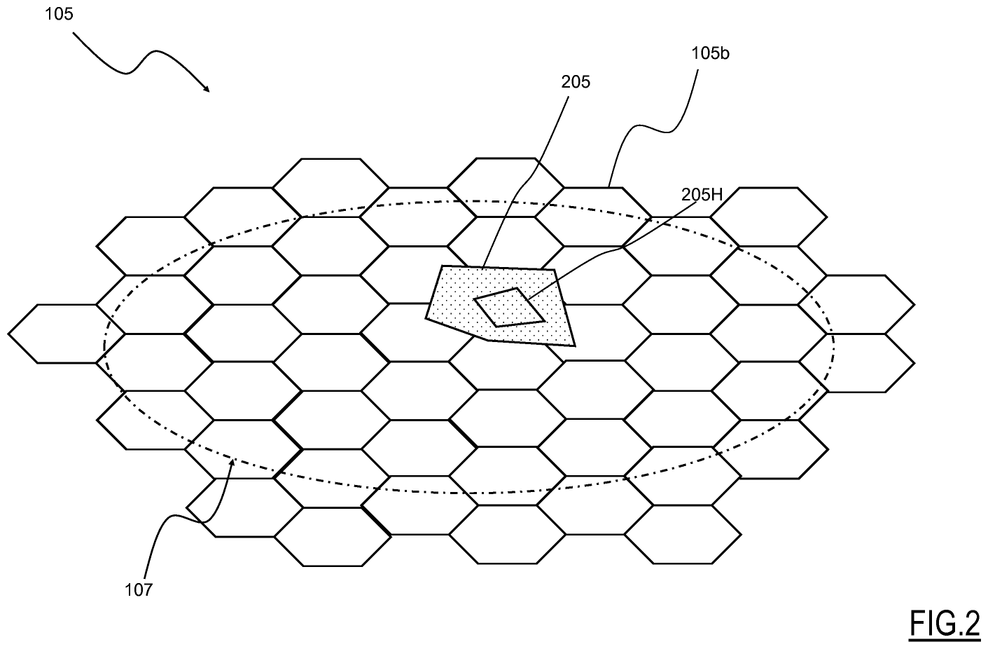

With reference to the drawings, FIG. 1 is a schematic representation of a system for evaluating one or more catchment areas (i.e., areas from which a city, an institution, or a business company attracts people that live, work, or use services provided by such institution and/or business company) associated with a transport hub, simply denoted as system 100 hereinafter, according to an exemplary embodiment of the present invention.

The system 100 allows performing an estimation of a number and of categories (e.g., incoming traveler, departing traveler, non-travelling partners, drivers, personnel, etc.) of persons that interact with a transport hub (e.g., an airport, a railway station, a bus station, etc., or a combination/superposition thereof, schematically shown in FIG. 2 where is indicated by reference 205H) during a predetermined observation time period T_{obs} (e.g., persons that reach, leave and/or spend time at the transport hub within the observation period).

It should be noted that the term ‘observation time period’ T_{obs} as used herein may comprise a predetermined time interval possibly comprising one or more time subintervals. For example, an observation time period may comprise a continuous time interval, for example, encompassing one or more selected days (e.g., expressed as a start date and time and an end date and time, such as for example an observation time period ranging from the first of September at 6:00 am to the second of September at 5:00 pm). Alternatively, the observation time period may comprise one or more subintervals that are periodically repeated, e.g., on a daily/weekly/monthly basis. For example, a non-continuous time interval may extend over a week, and may comprise a subinterval for each day of the week (e.g., each subinterval ranges from the 06:00 am to the 06:00 pm of a respective day of the week that builds up the time interval).

The system 100 is coupled with a mobile telecommunication network 105, such as a (2G, 3G, 4G or higher generation) mobile telecommunication network, and is configured for receiving from the mobile telecommunication network 105 positioning data of each User Equipment (UE in the following; e.g. a mobile phone, a smartphone, a tablet with 2G-3G-4G connectivity, etc.) of individuals located in a surveyed geographic area 107 (indicated in dash-and-dot line in FIG. 1), comprising but not limited to the transport hub, schematized in FIG. 1 as the area within the dash-and-dot line.

It should be noted that the terms ‘surveyed geographic area’ and ‘surveyed area’ 107 as used herein may comprise a ‘continuous’ geographic area, e.g. a county, a municipality, a city, one or more city blocks, etc. Alternatively, the surveyed area 107 may comprise one or more ‘non-contiguous’ geographic areas. For example, a surveyed area 107 may comprise two or more distant geographic regions, preferably each comprising a respective transport hub. Even more preferably, such transport hubs are connected by line routes of transportation vehicles, i.e. transportation means providing a transportation service along one or more line routes stopping at the transport hub, to the transport hub being analyzed.

The mobile telecommunication network 105 comprises a plurality of (two or more) communication stations 105a (e.g., radio base stations of the mobile telecommunication network) geographically distributed in the surveyed area 107. Each communication station 105a is adapted to manage communications of UE (not shown, such as for example mobile phones, smartphones, tablets, etc.) in one or more served areas or cells 105b (in the example at issue, three cells are served by each communication station 105a).

Generally, each communication station 105a of the mobile telecommunication network 105 is adapted to interact with any UE located within one of the cells 105b served by such communication station 105a (e.g., interactions at power on/off of the UE, at location area update, at incoming/outgoing calls, at sending/receiving SMS and/or MMS, at Internet access, etc.). Such interactions between UE and mobile telecommunication network 105 will be generally denoted as events eᵥ (v=1, . . . , V; V>0) in the following.

The surveyed geographic area 107 may be regarded as subdivided in a plurality of sectors, each corresponding to a respective cell 105b of the (part of the) mobile telecommunication network 105 superimposed on the surveyed area 107.

The system 100 comprises a computation engine 110 configured for processing data retrieved from the mobile telecommunication network 105, and a repository 115 (such as a database, a file system, etc.) for storing: data regarding interactions between the UE and the mobile telecommunication network 105, computation results generated by the computation engine 110 and, possibly, any processing data generated by and/or provided to the system 100 (generally in a binary format). The system 100 is provided with an administrator interface 120 (e.g., a computer) configured and operable for modifying parameters and/or algorithms used by the computation engine 110 and/or accessing data stored in the repository 115.

Preferably, the system 100 comprises one or more user interfaces 125 (e.g., a user terminal, a software running on a remote terminal connected to the system 100) adapted to receive inputs from, and to provide output to a user of the system 100. The term “user of the system” as used in the present disclosure may refer to one or more human beings and/or to external computing systems (such as a computer network, not shown) of a third party being subscriber of the services provided by the system 100 and enabled to access the system 100—e.g., under subscription of a contract with a service provider owner of the system 100, and possibly with reduced right of access to the system 100 compared to the right of access held by an administrator of the system 100 operating through the administrator interface 120.

It should be appreciated that the system 100 may be implemented in any known manner; for example, the system 100 may comprise a single computer, or a network of distributed computers, either of physical type (e.g., with one or more main machines implementing the computation engine 110 and the repository 115, connected to other machines implementing administrator 120 and user interface 125) or of virtual type (e.g., by implementing one or more virtual machines in a computer network).

Generally, the system 100 comprises, but is not limited to hardware, firmware, software or a combination thereof.

For example, the system 100 comprises, but is not limited to: one or more processes running on one or more processors; one or more data processors; one or more software objects; one or more executable computer programs; one or more threads of execution of computer programs, and/or one or more computing devices (e.g., the UE, the communication stations 105a as well as other elements of the mobile telecommunication network 105, and/or one or more general purpose or dedicated computers).

In other words, the computation engine 110, the repository 115, the administrator interface 120 and the user interface 125 may comprise one or more software applications being executed on a computing device and/or the computing device itself.

One or more among the computation engine 110, the repository 115, the administrator interface 120 and the user interface 125 may be implemented in one computing device and/or may be distributed between two or more computing devices.

The computation engine 110, the repository 115, the administrator interface 120 and the user interface 125 may comprise and/or interact with computer readable media capable of storing data (according to one or more data structures, e.g. in a binary format).

The computation engine 110, the repository 115, the administrator interface 120 and the user interface 125 may communicate by exploiting local and/or remote processes, preferably by means of electrical, electromagnetic and/or optical signals, preferably, providing one or more data packets, such as data packets from one entity interacting with another entity in a local system, in a distributed system, and/or across a radio network and/or a wired network.

The system 100 is adapted to retrieve (and/or receive) from the mobile telecommunication network 105 an event record erᵥ for each event eᵥ occurred between a UE and the mobile telecommunication network 105 (through one of its communication stations 105a) within the surveyed geographic area 107. Event records erᵥ are recorded by the mobile telecommunication network 105 upon the occurrence of corresponding events eᵥ. Preferably, each event record erᵥ comprises—in a non-limitative manner—an identifier id of the UE that is involved in the corresponding event eᵥ (e.g., the UE identifier may be selected as one or more among the International Mobile Equipment Identity—IMEI, the International Mobile Subscriber Identity—IMSI and the Mobile Subscriber ISDN Number—MSISDN code), time data (also denoted as timestamps) is indicating the time at which the corresponding event eᵥ has occurred, and UE geographical position data ps, e.g. spatial indications based on the cell 105b in which the UE is located at the time of occurrence of the corresponding event eᵥ.

In one embodiment of the present invention, the UE identifier of the UE involved in the event record erᵥ may be provided as encrypted information in order to ensure the privacy of the UE owner. Anyway, if the need arises, the encrypted information (i.e., the identity of the owner of the UE corresponding to the UE identifier) may be decrypted by implementing a suitable decryption algorithm, such as for example the algorithm SHA256 described in “Secure Hash Standard (SHS)”, National Institute of Standards and Technology FIPS—180-4, Mar. 6, 2052.

The system 100 may retrieve (and/or receive) the event records erᵥ related to a generic UE from the mobile telecommunication network 105 by acquiring records of data generated and used in the mobile telecommunication network 105. For example, in case the mobile telecommunication network 105 is a GSM network, Charging Data Records (CDR), also known as call data records, and/or Visitor Location Records (VLR) may be retrieved from the mobile telecommunication network 105 and reused as event records erᵥ. The CDR is a data record (usually exploited for billing purposes by a mobile telephony service provider operating through the mobile telecommunication network 105) that contains attributes specific to a single instance of a phone call or other communication transaction performed between a UE and the mobile telecommunication network 105. The VLR are databases listing UE that have roamed into the jurisdiction of a Mobile Switching Center (MSC, not shown) of the mobile telecommunication network 105, which is a management element of the mobile telecommunication network 105 managing events over a plurality of communication stations 105a. Each communication station 105a in the mobile telecommunication network 105 is usually associated with a respective VLR.

Conversely, if the mobile telecommunication network 105 is a LTE network, records of data associated with the event records erᵥ of a generic UE are generated by a Mobility Management Entity, or MME, comprised in the mobile telecommunication network 105, which is responsible for a UE tracking and paging procedure in LTE networks (where no VLR is implemented).

It should be noted that the method described in the present disclosure may be implemented by using any source of data (e.g., provided by one or more WiFi networks) from which it is possible to obtain event records erᵥ comprising a univocal identifier of individuals (such as the UE identifier mentioned above), position information of such individuals, and a time indication of an instant during which such event has occurred.

In operation, event records erᵥ may be continuously retrieved by the system 100 from the mobile telecommunication network 105. Alternatively, event records erᵥ may be collected by the system 100 periodically, e.g. during the observation time period T_{obs} of above. For example, event records erᵥ may be transferred from the mobile telecommunication network 105 to the system 100 as they are generated, in a sort of “push” modality, or event records erᵥ may be collected daily in the mobile telecommunication network 105 and then packed and transferred to the system 100 periodically or upon request by the system 100.

The event records erᵥ retrieved from the mobile telecommunication network 105 are stored in the repository 115, where they are made available to the computation engine 110 for processing. Preferably, event records erᵥ generated by a same UE are grouped together in the repository 115, i.e. event records erᵥ are grouped together if they comprise a common UE identifier and are denoted to as event records group ergₙ (e.g., n=0, . . . , N, N≥0) hereinafter.

Preferably, the computation engine 110 implements a procedure for identifying catchment areas associated with the transport hub (described in the following). For example, the computation engine 110 implements a software program product designed for identifying catchment areas associated with the transport hub that may be stored in a memory element 110a of the system 100 (comprised in the computation engine 110 in the example of FIG. 1), even though the software program product could be stored in the repository 115 as well (or in any other memory element provided in the system 100).

Even more preferably, the event records erᵥ are processed according to (as discussed in detail below) instructions provided by the system administrator (through the administrator interface 120), for example stored in the repository 115, and, possibly, according to instructions provided by a user (through the user interface 125).

Finally, the computation engine 110 provides the results of the processing performed on the event records erᵥ to the user through the user interface 125, and optionally stores such processing results in the repository 115.

It should be noted that the system 100 might be adapted to retrieve (or receive) data about individuals not exclusively from a mobile telecommunication network 105. Alternatively or in addition, the system may be configured to retrieve (or receive) data about individuals from one or more wireless computer networks, such as WLANs, operating in the surveyed area 107, provided that the UE of the individuals are capable to connect to such wireless computer networks.

Further, it should be noted that the system 100 may be configured for retrieving event records erᵥ associated with a pool of UEs. Preferably, such pool of UEs may comprise a portion of the UE that are associated with an event eᵥ of interaction with the mobile telecommunication network 105 to all the UEs associated with an event eᵥ of interaction with the mobile telecommunication network 105 (e.g., during the observation time period T_{obs}) according to instructions provided by the system administrator (through the administrator interface 120) and, possibly, according to instructions provided by a user (through the user interface 125)

FIG. 2 is a schematic representation of a surveyed area 107 within which an area of a transport hub, or hub area 205, is comprised. The hub area 205, which is schematically represented as a polygon superimposed to the surveyed area 107, substantially comprises the transport hub 205H i.e., all the facilities and infrastructures comprised in, and/or associated with, the transport hub 205H. For example, in case the considered transport hub 205H comprises an airport, a terminal, one or more hangars, a control tower, one or more ramps, runways, aircrafts stands, maintenance and firefight buildings, parking lots etc.

It should be apparent that in other embodiments of the present invention an ‘aggregated’ hub area may be defined as the aggregation of facilities comprised in, and/or associated with, two or more transport hubs. In other words, the aggregated hub area is a union of the hub areas associated with the two or more transport hubs considered. For example an aggregated hub area may be defined by the aggregation of the airports of a nation, or by the aggregation of bus stations, train stations, and underground stations comprised in a same city (e.g., in order to analyze data on a nationwide or citywide scale). Advantageously, the analysis of individuals reaching or leaving the aggregated hub areas still provides information also on individuals that reach or leave each one of the hub areas comprised in the aggregate hub area.

According to an embodiment of the invention, the system 100 allows counting persons that have been at the hub area 205 within the observation time period T_{obs} (i.e., individuals whose UE have generated one or more events eᵥ localized within the hub area 205 during the observation period and recorded as a corresponding event record erᵥ), and classifying each person, or individual, according to two or more categories of individuals.

As a non-limiting example, the following seven categories may be defined for individuals:
A category: departing individuals, i.e. people that leave (e.g., by taking an outgoing flight at an airport) the hub area 205 by taking an outgoing transportation means;
B category: arriving individuals, i.e. people that arrive (e.g., by taking an incoming flight at an airport) at the hub area 205 exploiting a transportation means;
C category: outgoing commuting individuals, i.e. people that leave the hub area 205 and then return back to the hub area 205, exploiting transportation means, within the observation time period T_{obs};
D category: incoming commuting individuals, i.e. people that arrive at the hub area 205 and then leave the hub area 205, exploiting transportation means, within the observation time period T_{obs};
E category: non-travelling individuals, i.e. people that reach/leave the hub area 205 without exploiting the transport means (e.g., aircrafts) of the transport hub (e.g. chauffeurs, taxi drivers, bus drivers, partners of the travelling individuals, etc.);
F category: individuals part of the personnel of the transport hub 205H, personnel individuals in the following, i.e. people that works at the hub area 205, and
G category: other individuals, i.e. this category comprises all the people that are not identified as belonging to one of the preceding categories.

Advantageously, categories, such as categories A to G listed above, may be selected for the analysis according to requests from an enterprise managing the transport hub 205H or any other party that requires an analysis of people accessing the transport hub 205H.

In an embodiment of the invention, the administrator interface 120 and, preferably, the user interface 125 are configured for allowing an administrator or a user, respectively, to select, modify, delete and/or define categories of individuals to be identified by the process implemented by the system 100 (as described in the following).

According to the present invention, each category A to G is associated with one or more corresponding patterns of events, or events patterns eᵥ, i.e. sequences of events eᵥ common to the individuals of a same category A to G.

Preferably, the events patterns comprise one or more (first) sets of mandatory events and, optionally, one or more (second) sets of optional events. The mandatory events are events that have to be found among the events eᵥ associated with the UE of an individual for identifying the latter as belonging to a corresponding category. Conversely, optional events are events that may be found among the events eᵥ associated with the UE of an individual belonging to a corresponding category.

Preferably, for each individual a first event eᵥ of an events pattern may correspond to the event eᵥ associated with a first event record erᵥ detected during the considered observation time period T_{obs}.

Conversely, a last event eᵥ of an events pattern may correspond to the event eᵥ associated with a last event record erᵥ recorded during the observation time period T_{obs}, or the last event eᵥ of an events pattern may correspond to the event ev preceding the identification of the occurrence of a predetermined ‘termination’ condition.

For example, a termination condition may be defined as a ‘power off’ event associated with the UE (i.e., the UE is turned/switched off or put in airplane mode, such as for example before the takeoff phase of a flight), when a UE lose connection with the mobile telecommunication network 105 (e.g., when a ship is offshore), or when a ‘termination sequence’ is detected.

In an embodiment of the invention, a termination sequence may comprise two or more events recorded at, possibly predetermined, locations separated by a minimum distance one another. In other words, the termination sequence indicates that the UE is leaving the hub area on a land transportation means such as a train or a bus—e.g., the termination sequence comprises one or more events recorded in correspondence of cells 105b (known to be) positioned along routes travelled by transportation means, and recorded at time intervals compatible with an average speed of the transportation means.

For example, an events pattern Ap is associated with A category, an events pattern Bp is associated with B category, an events pattern Cp is associated with C category, an events pattern Dp is associated with D category, events patterns Ep₁, Ep₂ and Ep₃ are associated with E category, events patterns Fp₁, Fp₂ and Fp₃ are associated with F category, and an events pattern Gp is associated with G category. It should be noted, that the events pattern Gp associated with the G category may remain undefined, since individuals may be considered belonging to the G category when any one of the patterns Ap to Fp is not identified while analizying the respective events records group ergₙ.

The events patterns Ap to Fp according to an embodiment of the invention are described hereinbelow.

The events pattern Ap, i.e. pattern of events associated with departing individuals, comprises the following events sets.
Ap.a: (mandatory) one or more consecutive events eᵥ detected (i.e., recorded as event record erᵥ) within the surveyed area 107, but outside the hub area 205;
Ap.b: (mandatory, and possibly comprising the last event eᵥ recorded for the events pattern Ap, if the events set Ap.c as described below is not present) a single event eᵥ detected within the hub area 205 subsequent to the detection of event set Ap.a;
Ap.c: (optional, and comprising the last event eᵥ recorded for the events pattern Ap, if present) one or more consecutive events eᵥ detected within the hub area 205 subsequent to event set Ap.b. Particularly, the events eᵥ of the events set Ap.c should possess the following features:
   Ap.c₁: a (first) time interval Δtₐ₁ between the event eᵥ of the events set Ap.b and any event eᵥ of the events set Ap.c is equal to, or lower than, a permanence time period Tperm (described in the following), and
   Ap.c2: a (second) time interval Δtₐ₂ between consecutive events eᵥ of the events set Ap.c is equal to, or lower than, a (first) threshold time period Tv_out (described in the following).

Pattern Bp, i.e. pattern of events associated with arriving individuals, comprises the following events sets.
Bp.a: (mandatory) a single event eᵥ detected within the hub area 205;
Bp.b: (optional) one or more consecutive events eᵥ detected within the hub area 205. Particularly, the events eᵥ of the event set Bp.b should possess the following feature:
   Bp.b₁: a (third) time interval Δt_{b1} between the event eᵥ of the events set Bp.a and any event eᵥ of the events set Bp.b is equal to, or lower than, the permanence time period Tperm, and
Bp.c: (mandatory, and comprising the last event eᵥ recorded for the events pattern Bp) one or more consecutive events eᵥ detected within the surveyed area 107, but outside the hub area 205.

The event pattern Cp, i.e. pattern of events associated with departing commuting individuals, comprises the following events sets.
Cp.a: (mandatory) a sequence of events eᵥ according to pattern Ap (e.g., at least comprising the mandatory events sets Ap.a and Ap.b);
Cp.b: (mandatory, and possibly comprising the last event eᵥ recorded for the events pattern Cp) a single event eᵥ detected within the hub area 205, preferably, possessing the following feature:
   Cp.b₁: a (fourth) time interval Δt_{c1} between the event eᵥ of the event set Cp.b and a last event eᵥ of the events set Cp.a is greater than the (first) threshold time period Tv_out;
Cp.c: (optional, and possibly comprising the last event eᵥ recorded for the events pattern Cp, if present) one or more consecutive events eᵥ detected within the hub area 205. Preferably, the events eᵥ of the events set Cp.c possess the following feature:
   Cp.c₁: a (fifth) time interval Δt_{c2} between the event eᵥ of the events set Cp.b and any event eᵥ of the events set Cp.c is equal to, or lower than, the (first) permanence time period Tperm, and
Cp.d: (optional, and comprising the last event eᵥ recorded for the events pattern Cp, if present) one or more consecutive events eᵥ detected within the surveyed area 107, but outside the hub area 205.

The event pattern Dp, i.e. pattern of events associated with arriving commuting individuals, comprises the following events sets.
Dp.a: (mandatory) a sequence of events eᵥ according to pattern Bp (e.g., at least comprising the mandatory events sets Bp.a and Bp.c);
Dp.b: (mandatory, and possibly comprising the last event eᵥ recorded for the events pattern Dp, if the events set Dp.c as described below is not present) a single event eᵥ detected within the hub area 205, preferably, possessing the following feature:
   Dp.b₁: a (sixth) time interval Δt_{d1} between the event eᵥ of the event set Dp.b and a last event eᵥ of the events set Dp.a is greater than a (second) threshold time period Tv_in (described in the following), and
Dp.c: (optional, and comprising the last event eᵥ recorded for the events pattern Dp, if present) one or more consecutive events eᵥ detected within the hub area 205. Preferably, the events eᵥ of the events set Dp.c possess the following feature:
   Dp.c₁: a (seventh) time interval Δt_{d2} between the event eᵥ of the events set Dp.b and any event eᵥ of the events set Dp.c is equal to, or lower than, the permanence time period Tperm.

The events patterns Ep₁, Ep₂ and Ep₁, i.e. patterns of events associated with non-travelling individuals, comprise the following three alternative events sets combinations.

A first events pattern Ep₁ comprises the following events sets:
Ep₁.a: (mandatory) a sequence of events eᵥ according to pattern Ap (e.g., at least comprising the mandatory events sets Ap.a and Ap.b), and
Ep₁.b: (mandatory, and comprising the last event eᵥ recorded for the events pattern Ep) one or more consecutive events eᵥ detected within the surveyed area 107, but outside the hub area 205.

A second events pattern Ep₂ comprises the following events sets:
Ep₂.a: (mandatory) a sequence of events eᵥ according to pattern Bp (e.g., at least comprising the mandatory events sets Bp.a and Bp.c), and
Ep₂.b: (mandatory, and comprising the last event eᵥ recorded for the events pattern Ep) a single event eᵥ detected within the hub area 205, preferably, possessing the following feature:
   Ep₂.b₁: a (eigth) time interval Δtₑ₁ between the event eᵥ of the event set Ep₂.b and a last event eᵥ detected in the hub area 205 of the events set Ep₂.a (i.e., event eᵥ of events set Bp.a or Bp.c if present) is equal to, or lower than, the (second) threshold time period Tv_in

A third events pattern Ep₃ comprises the following events sets:
Ep₃.a: (mandatory) a sequence of events eᵥ according to pattern Dp (e.g., at least comprising the mandatory events sets Dp.a and Dp.b), and
Ep₃.b: (mandatory, and comprising the last event eᵥ recorded for the events pattern Ep) one or more consecutive events eᵥ detected within the surveyed area 107, but outside the hub area 205.

The events patterns Fp₁, Fp₂ and Fp₃, i.e. patterns of events associated with transport hub 205H personnel individuals comprise the following three alternative events sets combinations.

A first events pattern Fp₁ comprises the following events sets:
Fp₁.a: (mandatory) a sequence of events eᵥ according to pattern Ap (e.g., at least comprising the mandatory events sets Ap.a and Ap.b);
Fp₁.b: (mandatory, and comprising the last event eᵥ recorded for the events pattern Fp) a single event eᵥ detected within the hub area 205, preferably, possessing the following feature:
   Fp₁.b₁: a (ninth) time interval Δt_{f1} between the event eᵥ of the events set Fp₁.b and a first event eᵥ of the events set Fp₁.a is greater than the permanence time period Tperm.

A second events pattern Fp₂ comprises the following events set:
Fp₂.a: (mandatory, and comprising the last event eᵥ recorded for the events pattern Fp) one or more consecutive events eᵥ detected within the hub area 205. Preferably, the events eᵥ of the events set Fp₂.a possess the following feature:
   Fp₂.a₁: a (tenth) time interval Δt_{f2} between the first event eᵥ of the events set Fp₂.a and any one of the other events eᵥ of the events set Fp₂.a is greater than the permanence time period Tperm.

A third events pattern Fp₃ comprises the following events set:
Fp₃.a: (mandatory) a sequence of events eᵥ according to pattern Dp (e.g., at least comprising the mandatory events sets Dp.a and Dp.b), and
Fp₃.b: (mandatory, and comprising the last event eᵥ recorded for the events pattern Fp) one or more events eᵥ detected within the hub area 205, preferably, possessing the following feature:
   Fp₃.b₁: a (eleventh) time interval Δt_{f3} between the event eᵥ of the event set Dp.b and a first event eᵥ of the events set Fp₃.b is greater than the permanence time period Tperm.

The events pattern Gp, i.e. pattern of events associated with other individuals, comprises any sequence of events eᵥ different from any one of the events sequences described above with respect to patterns Ap to Fp (in particular for the events sets classified as mandatory).

In summary, according to a preferred embodiment of the invention, a generic sequence of events eᵥ recorded during the observation time period T_{obs} is identified to correspond to one of the events pattern Ap-Fp₃ described above whether the sequence of events eᵥ comprises all the mandatory events sets associated with such one events pattern Ap-Fp₃, and whether the last recorded event eᵥ of the generic sequence of events eᵥ recorded within the observation time period T_{obs} is comprised in a last mandatory event set of the one events pattern Ap-Fp₃, or the last recorded event eᵥ is comprised in a last optional event set of the one events pattern Ap-Fp₃ (i.e., the last recorded event eᵥ of the generic sequence of events eᵥ corresponds to the last event eᵥ of the one events pattern Ap-Fp₃).

For example, a sequence of events eᵥ recorded during the observation time period T_{obs} corresponds to events pattern Ap whether both mandatory events sets Ap.a and Ap.b are identifiable in the sequence of events eᵥ, and the last event eᵥ of the sequence of events eᵥ is comprised in the mandatory events set Ap.b (i.e., the last event eᵥ of the sequence of events eᵥ is the last event eᵥ associated with the mandatory events set Ap.b) or the last event eᵥ of the sequence of events eᵥ is comprised in the optional events set Ap.c (i.e., the last event eᵥ of the sequence of events eᵥ is the last event eᵥ associated with the optional events set Ap.c) if the latter is identified in the sequence of events eᵥ.

A sequence of events eᵥ recorded during the observation time period T_{obs} corresponds to the events pattern Bp whether mandatory events sets Bp.a to Bp.c are identifiable in the sequence of events eᵥ, and the last event eᵥ of the sequence of events eᵥ is comprised in the mandatory events set Bp.c.

A sequence of events eᵥ recorded during the observation time period T_{obs} corresponds to events pattern Cp whether both mandatory events sets Cp.a and Cp.b are identifiable in the sequence of events eᵥ, and the last event eᵥ of the sequence of events eᵥ is comprised in the mandatory events set Cp.b, or in the optional events set Cp.c if identified in the sequence of events eᵥ while the optional events set Cp.d is not identified, or in the optional events set Cp.d if identified in the sequence of events eᵥ.

A sequence of events eᵥ recorded during the observation time period T_{obs} corresponds to events pattern Dp whether both mandatory events sets Dp.a and Dp.b are identifiable in the sequence of events eᵥ, and the last event eᵥ of the sequence of events eᵥ is comprised in the mandatory events set Dp.b or in the optional events set Dp.c if the latter is identified in the sequence of events eᵥ.

A sequence of events eᵥ recorded during the observation time period T_{obs} corresponds to events pattern Ep₁, Ep₂ or Ep₁, respectively, whether mandatory events sets Ep₁.a and Ep₁.b, Ep₂.a and Ep₂.b or Ep₃.a and Ep₃.b, respectively, are identifiable in the sequence of events eᵥ, and the last event eᵥ of the sequence of events eᵥ is comprised in the mandatory events set Ep₁.b, Ep₂.b or Ep₃.b, respectively.

A sequence of events eᵥ recorded during the observation time period T_{obs} corresponds to events pattern Fp₁, Fp₂ or Fp₃, respectively, whether mandatory events sets Fp₁.a and Fp₁.b, Fp₂.a or Fp₃.a and Fp₃.b, respectively, are identifiable in the sequence of events eᵥ, and the last event eᵥ of the sequence of events eᵥ is comprised in the mandatory events set Fp₁.b, Fp₂.a or Fp₃.b, respectively.

It should be noted that nothing prevents the administrator and/or the user of the system from modifying the criteria for identifying events patterns Ap to Gp from what just described in order to satisfy local and specific requirements without departing from the scope of the present invention.

In an alternative embodiment of the invention, a generic sequence of events eᵥ may be considered to correspond to more than one events pattern Ap to Gp, provided that at least the mandatory events sets comprised in the one or more events pattern Ap to Gp are identifiable in the sequence of events eᵥ.

For example, in case the events sets Ap.a, Ap.b and Cp.b are identified in the generic sequence of events eᵥ, the latter may be associated to the events pattern Cp (since events sets Ap.a, Ap.b are comprised in the mandatory events set Cp.a) and may also be associated to the events pattern Ap regardless the fact that the events set Cp.b comprises the last event eᵥ of the sequence of events eᵥ.

Preferably, the permanence time period Tperm corresponds to a time period spent at the transport hub 205H above which an individual cannot be considered a traveler (outgoing, incoming and/or commuting individuals) or a partner of a traveler. Therefore, individuals spending a time period at the transport hub 205H greater than the permanence time period Tperm are considered personnel of the transport hub 205H. In an embodiment of the invention, the permanence time period Tperm is set to a respective default value equal to six hours (i.e., Tperm=6 hr).

Preferably, the (first) threshold time period Tv_out corresponds to a minimum duration of an outgoing round trip, starting and ending within the hub area 205 within the observation time period T_{obs} (i.e., the trip of an outgoing commuting individual). In an embodiment of the invention, the permanence time period Tv_out is set to a default value equal to 7 hours (i.e., Tv_out=7 hr).

Preferably, the (second) threshold time period Tv_in corresponds to a minimum time period spent by an individual within the surveyed area 107, starting and ending within the hub area 205 during the observation time period T_{obs} (i.e., the trip of an arriving commuting individual). In an embodiment of the invention, the permanence time period Tv_in is set to a default value equal to 4 hours (i.e., Tv_in =4 hr).

In one embodiment of the invention, the default values for the time periods Tperm, Tv_out and Tv_in are selected based on an analysis of the behavior of a sample of users.

Preferably such default values may be modified according to (as discussed in detail below) instructions (which are for example stored in the repository 115) provided by the system administrator (through the administrator interface 120) and/or, possibly, according to instructions provided by a user (through the user interface 125).

The identification of categories of individuals that reach/leave the hub area 205 allows defining (as described in the following) a plurality of catchment areas, or category catchment areas, each referred to a distinct category A to G of individuals in addition to defining a more generic catchment area of the transport hub 205H.

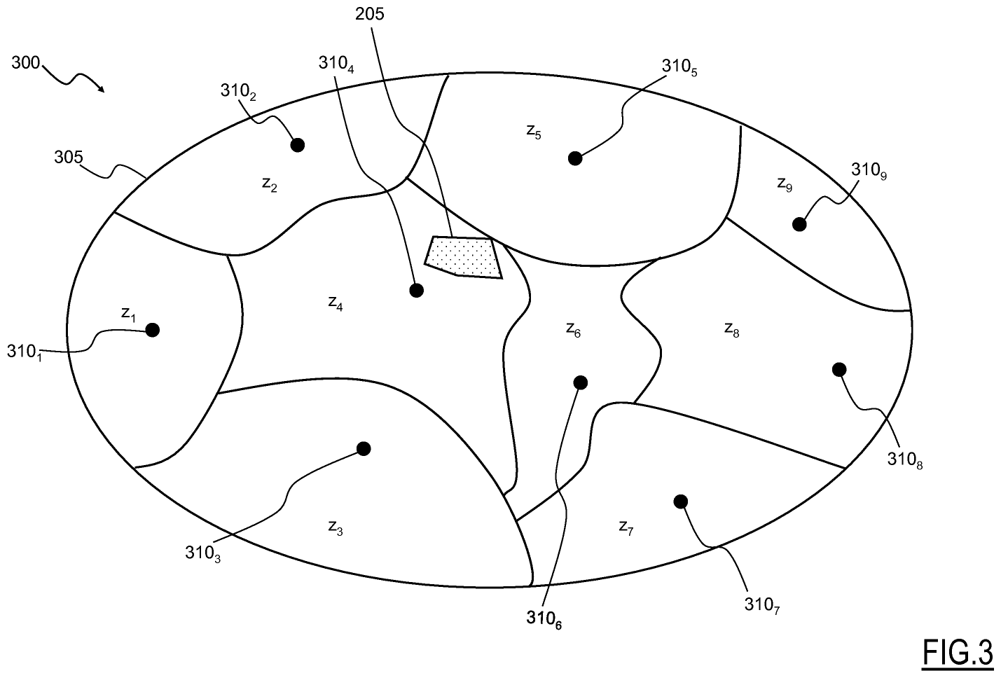

FIG. 3 is a schematic view of a geographic Region of Interest 300, in the following simply denoted as Rol 300, which is a generally different entity with respect to the surveyed area 107 defined above and is not to be mistaken with the latter.

The Rol 300 is a selected geographic region within which an analysis of the events eᵥ is performed in order to compute the Catchment Area matrix according to an embodiment of the present invention. The Rol 300 may be either a district, a town, a city, or any other kind of geographic area. Moreover, the Rol 300 may comprise a number of sub-regions having non-adjacent geographical locations, such as for example a plurality of different cities, different counties and/or different nations (and so on).

It should be noted that the Rol 300 size and extent is not limited by the surveyed area 107 size and/or geographical location. Indeed, the Rol 300 may be comprised in the surveyed area 107, the Rol 300 may be at least partially superimposed to the surveyed area 107 or the Rol 300 may be external to the surveyed area 107.

For example, the Rol 300 may be defined by (any available) zoning techniques, which is generally independent from the definition of the surveyed area 107 and/or from the area covered by the mobile telecommunication network 105 (and/or other telecommunication networks).

Preferably, although not limitatively, the Rol 300 is superimposed to the mobile telecommunication network 105 (in order for the system 100 to acquire event records erᵥ of events eᵥ occurring within the entirety of the Rol 300).

The Rol 300 is delimited by a boundary, or external cordon 305. The Rol 300 is subdivided into a plurality of traffic analysis zones, or simply zones z_{q} (q=1, . . . , Q; where Q is an integer number, and Q>0) in which it is desired to analyze traffic flows. In the example shown in FIG. 3, the Rol 300 is subdivided into nine zones z₁, . . . , z₉ (i.e., Q=9).

Each zone z_{q} may be advantageously determined by using the already described zoning technique. According to this technique, each zone z_{q} may be delimited by administrative (city limits, National boundaries, etc.) and/or physical barriers (such as rivers, railroads etc.) within the Rol 300 that may hinder the traffic flow and may comprise adjacent lots of a same kind (such as open space, residential, agricultural, commercial or industrial lots) which are expected to experience similar traffic flows. It should be noted that the zones z_{q} may differ in size one another. Generally, each zone z_{q} is modeled as if all traffic flows starting or ending therein were concentrated in a respective single point or centroid 310_{q} (i.e., 310₁, . . . , 310₉). In other words, the centroid 310_{q} of the generic zone z_{q} represents an ideal interchange node from or at which any traffic flow starts or ends, respectively, for the zone z_{q}.

Anyway, it is pointed out that the solution according to embodiments of the present invention is independent from the criteria used to partition the Rol 300 into zones z_{q}.

In one embodiment of the invention, the catchment area of the transport hub 205H and/or the category catchment areas are identified by associating one or more zones z_{q} of the Rol 300 with the individuals that interact with transport hub 205H (as described hereinbelow).

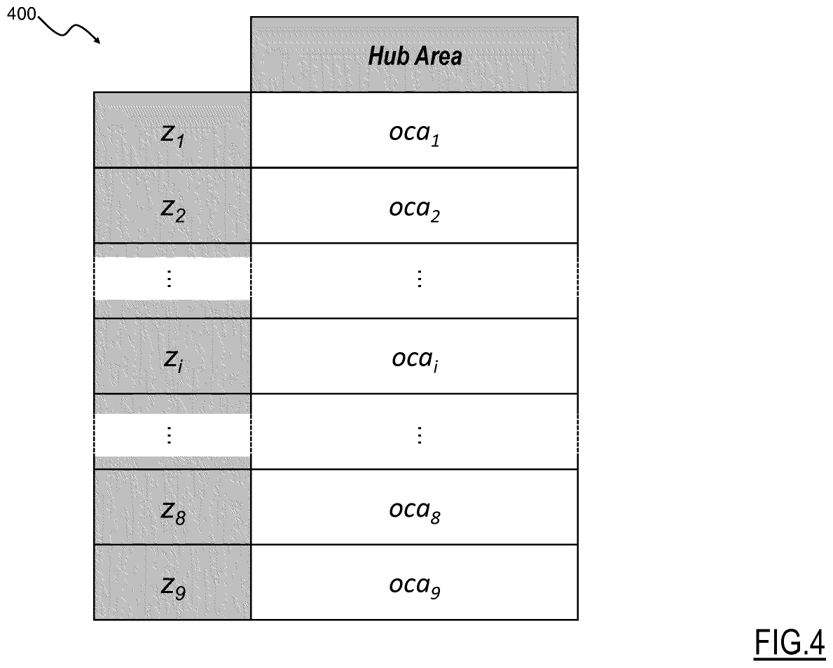

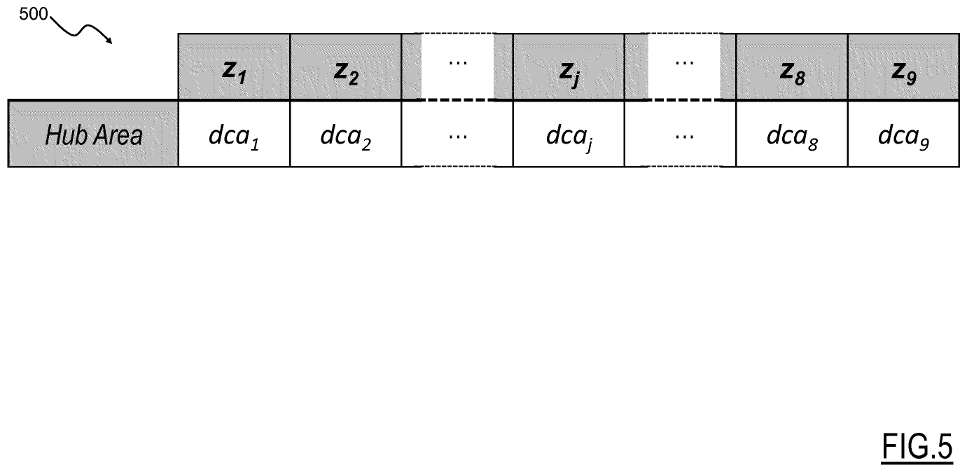

FIGS. 4 and 5 are two distinct Catchment Area matrices referred to the zones z_{q} in which the Rol 300 is subdivided.

Particularly, FIG. 4 is an Origin Catchment Area (OCA) matrix 400, a vector in the considered example, which describes, for individuals that reached/leaved the hub area 205 (i.e., associated with at least an event eᵥ recorded within the hub area 205) during the observation time period T_{obs}, which is/are the zone/s z_{q} where the individuals prevalently stay during a previous time period Tₚᵣₑᵥ. The previous time period Tₚᵣₑᵥ (which may comprise continuous time interval or non-contiguous time subintervals) occurs before the observation time period T_{obs}.

FIG. 5 is a Destination Catchment Area (DCA) matrix 500, a vector in the considered example, which describes, for the individuals that reached/leaved the hub area 205 (i.e., associated with at least an event eᵥ recorded within the hub area 205) during the observation time period T_{obs}, which is/are the zone/s z_{q} where the individuals prevalently stay during a successive time period T_{obs}. The successive time period T_{suc} (which may comprise continuous time interval or non-contiguous time subintervals) occurs after the observation time period T_{obs}.

The OCA matrix 400, in the example of FIG. 4, has Q rows and one single column (and, therefore may be considered a vector). Each row is associated with a corresponding zone z_{q} of the Rol 300; thus, the OCA matrix 400 comprises nine rows i=1, . . . , 9. The single column of the OCA matrix 400 is associated with the hub area 205. Therefore, the generic i-th element (or entry) of the OCA matrix 400, identified as element ocaᵢ, represents the number of individuals that stay prevalently in the i-th zone zᵢ (during the previous time period Tₚᵣₑᵥ) before reaching the hub area 205 (during the observation time period T_{obs}).

The DCA matrix 500 in the example of FIG. 5 has one single row and Q columns (and, therefore may be considered a vector). Each column is associated with a corresponding zone z_{q} of the Rol 300; thus, the DCA matrix 500 comprises nine columns j=1, . . . , 9. The single row of the DCA matrix 500 is associated with the hub area 205. Therefore, the generic j-th element of the DCA matrix 500, identified as element dcaⱼ, represents the number of individuals that stay prevalently in the j-th zone zⱼ (during the successive time periodo T_{suc}) after having left the hub area 205 (during the time observation period T_{obs}).

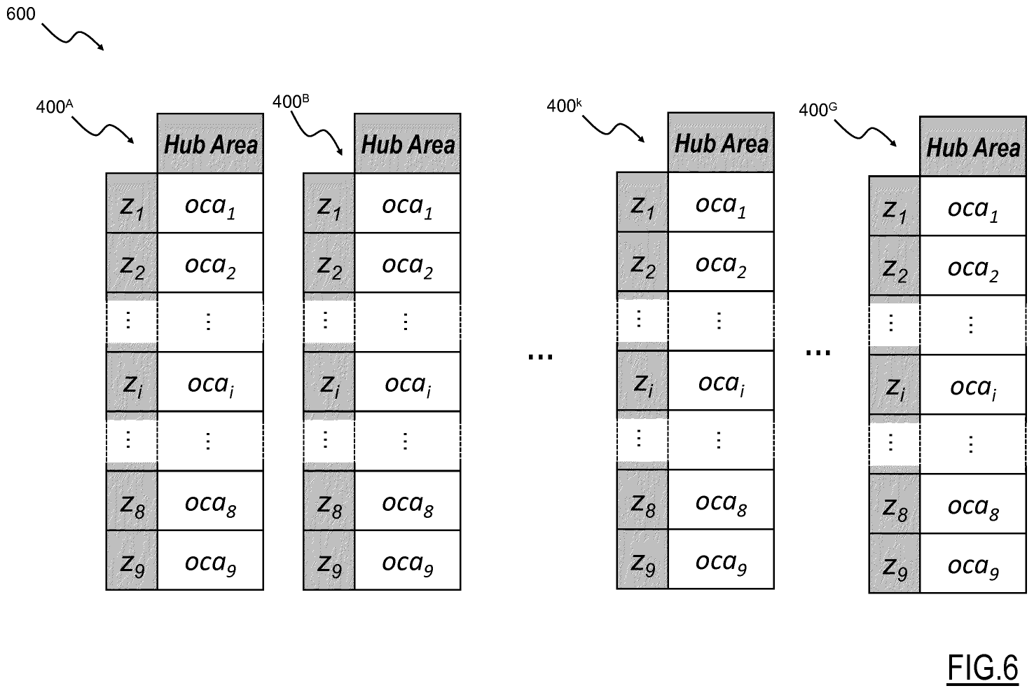

Preferably, a set 600 of Origin Catchment Area matrices 400 comprises a respective Origin Catchment Area matrix for each category A to G. As shown in the non-limiting example of FIG. 6, the set 600 may comprise up to seven OCA^{k} matrices 400^{k} (where k=A, B, C, D, E, F, G in the example of FIG. 6), i.e. one for each respective category A to G of individuals that reached the hub area 205 during the observation time period T_{obs}.

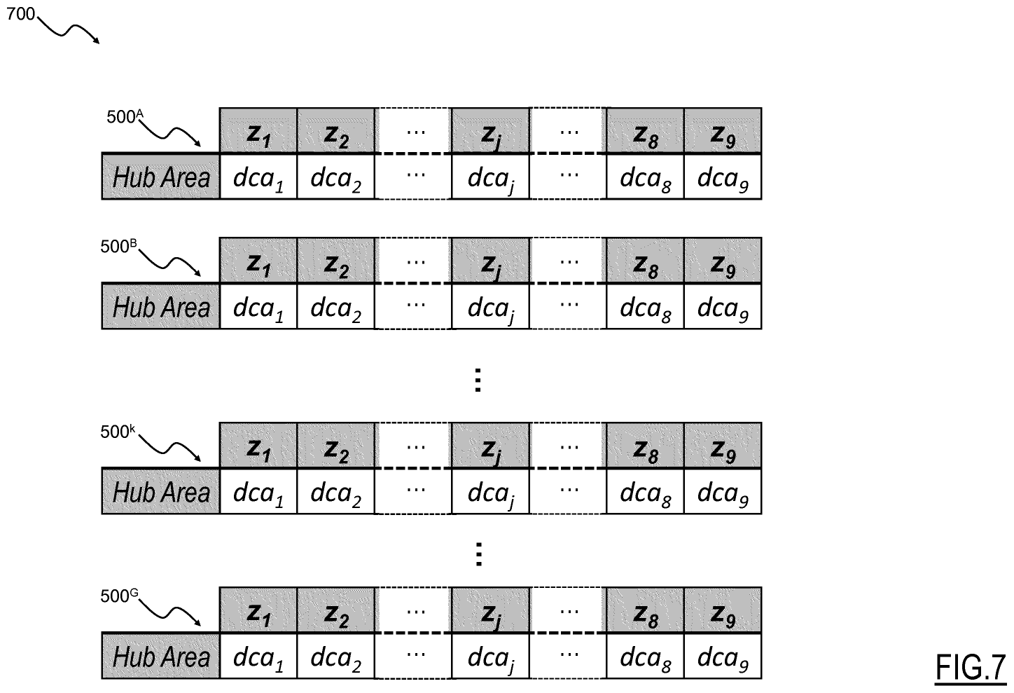

Similarly, a set 700 of Destination Catchment Area matrices 500 comprises a respective Origin Catchment Area matrix for each the category A to G. As shown in the non-limiting example of FIG. 7, the set 700 may comprise up to seven DCA^{k} matrices 500^{k} (where k=A, B, C, D, E, F, G in the example of FIG. 7), i.e. one for each respective category A to G of individuals that left the hub area 205 during the observation time period T_{obs}.

In one embodiment of the invention, prevalence zones zpᵢ and zpⱼ where each individual prevalently stays, or that each individual prevalently visits, before (for the OCA^{k} matrices 400^{k}) and after (for the DCA^{k} matrices 500^{k}) being in the hub area 205, may be identified based on the analysis of events records erᵥ associated with the individual during the previous time period Tₚᵣₑᵥ and the successive time period T_{suc}, respectively.

In one embodiment of the invention, the origin (for the OCA^{k} matrices 400^{k}) and destination (for the DCA^{k} matrices 500^{k}) zones z_{q} prevalently visited by individuals and the value of the elements ocaᵢ and dcaⱼ, respectively, are evaluated as described in the following.

Given the event record group ergₙ associated with a generic n-th UE (carried by a corresponding individual), all the event records erᵥ of the event record group ergₙ having a timestamp tsᵥ comprised in the previous time period Tₚᵣₑᵥ or the successive time period T_{suc}, whether the origin zone zᵢ or the destination zone zⱼ, respectively, is searched, are initially identified.

Afterwards, for each event record erᵥ previously identified, the corresponding position data pᵥ is analyzed and is associated with a corresponding zone z_{q} of the Rol 300 (i.e., the zone z_{q} of the Rol 300 comprising the location associated with the position data pᵥ). Once all the (previously identified) event records erᵥ have been considered, it is possible to identify the prevalence zone zpᵢ or zpⱼ where the individual prevalently stays before or after being in the hub area 205, respectively, as the zone z_{q} of the Rol 300 to which the greatest number of (previously identified) event records erᵥ is associated.

Accordingly, the values ocaᵢ or dcaⱼ of the OCA^{k} matrix 400^{k} and DCA^{k} matrix 500^{k}, respectively, associated with the origin prevalence zone zpᵢ or the destination prevalence zone zpⱼ just found, is increased (e.g., by a unit).

It should be noted that different procedure for identifying the origin prevalence zone zpᵢ or the destination prevalence zone zpⱼ can be exploited without departing from the scope of the present invention.

In an alternative embodiment of the invention, once all the (previously identified) event records erᵥ have been considered, a subset of zones z_{q} of the Rol 300 may be considered as a group of prevalence zones instead of a single prevalence zone as described. For example, two or more prevalence zones zpₓᵢ or zpₓⱼ (x=1, . . . , X, 0<X<Q) where the individual prevalently stays before or after, respectively, being in the hub area 205 may be defined.

Generally, a fixed number a of prevalence zones may be set by the administrator (or by the user) of the system 100 (i.e., the first a zones z_{q} associated with the greater number of event records erᵥ are identified as prevalence zones) or a predetermined (minimum) threshold number of event records may be set in order to identify one or more zones z_{q} as a prevalence zone for the owner of the n-th UE.

For example, two prevalence zones zp₁ᵢ and zp₂ᵢ, (or zp₁ᵢ and zp₂ᵢ) associated with the greatest numbers of (previously identified) event records erᵥ recorded before (or after) reaching the hub area 205, respectively, may be considered. In this case, given that n₁ᵢ (or n₁ⱼ) is the number of event records erᵥ associated with the (first) prevalence zone zp₁ᵢ (or zp₁ⱼ) and n₂ᵢ is the number of event records erᵥ associated with the (second) prevalence zone zp₂ᵢ (or zp₂ⱼ) the corresponding values oca₁ᵢ, and oca₂ᵢ (or dca₁ⱼ and dca₂ⱼ) in the OCA^{k} matrix 400^{k} (or DCA^{k} matrix 500^{k}) may be determined as averaged values as described in the following.

Preferably, the value ° cal, is given by:

$${oca}_{1 i} = \frac{{n}_{1 i}}{{n}_{1 i} + {n}_{2 i}} ,$$

and the value oca₂ᵢ is given by:

$${oca}_{2 i} = \frac{{n}_{2 i}}{{n}_{1 i} + {n}_{2 i}} .$$

Similarly, value dca₁ⱼ is given by:

$${dca}_{1 j} = \frac{{n}_{1 j}}{{n}_{1 j} + {n}_{2 j}} ,$$

and value dca₂ⱼ is given by:

$${dca}_{2 j} = \frac{{n}_{2 j}}{{n}_{1 j} + {n}_{2 j}} .$$

In one embodiment of the invention, the administrator interface 120 and, preferably, the user interface 125 are configured for allowing an administrator or a user, respectively, to select and/or modify the procedure for identifying the origin prevalence zone(s) zpᵢ or the destination prevalence zone(s) zpⱼ of individuals implemented by the system 100 (as described in the following).

It should be noted that, for each category A to G considered, a respective previous time period Tₚᵣₑᵥ, a respective successive time period T_{suc} and, possibly, a respective observation time period T_{obs} may be defined (as described in the following).

In an embodiment of the invention, the previous time period Tₚᵣₑᵥ and/or the successive time period may comprise two or more (relevant) time windows during which event records are considered. Preferably, consecutive time windows are separated by idle periods, events recorded during such idle periods are disregarded by the system 100.

For example, the previous time period Tₚᵣₑᵥ may be defined by a previous daily (time) window twₚ=[Ts, Te]—wherein Ts is a start time of the previous time window twₚ and Te is an end time or the time window twₚ—which is considered over a plurality of, preferably consecutive, days gₚ (e.g., p=1, 2, . . . , P; P>0) before the start of the observation time period T_{obs} (as described in the following).

Similarly, the successive time period T_{suc} may be defined by a successive daily (time) window twₛ=[Ts′, Te′], wherein Ts′ is a start time of the time window twₛ and Te′ is an end time or the successive time window twₛ which is considered over a plurality of, preferably consecutive, days gₛ (e.g., s=1, 2, . . . , S; S>0) after the end of the observation time period T_{obs} (as described in the following).

For example, in order to identify a catchment area for the transport hub 205H, the zones where individuals belonging to various categories A to G usually spend the nighttime may be considered. In this case, the previous time period Tₚᵣₑᵥ and the successive time period T_{suc} are defined comprising a number of days sufficient to determine the usual zones z_{q} in which the individuals usually stay during nighttime, for example the previous time period Tₚᵣₑᵥ and the successive time period T_{suc} are set equal to a week (i.e., seven days) preceding and following the observation time period T_{obs}, respectively.

Preferably, the previous and successive daily windows twₚ and twₛ may be defined as follows for each category A to G.

For the individuals of the A category only an origin catchment area matrix, or OCA^{A} matrix 400^{A}, may be computed, since the destination of departing individuals is generally not used in assessing the catchment area associated with the transport hub 205H (comprised in the hub area 205) under examination.

In this case, the start time Ts of the previous daily (time) window twₚ may be set equal to 18:00 (Ts=18:00) of a day comprised in previous time period Tₚᵣₑᵥ, and the end time Te thereof may be set equal to 08:00 (Te=08:00) of a following day comprised in the previous time period Tₚᵣₑᵥ. In other words, the previous daily (time) window twₚ ranges from 18:00 of a first day to the 08:00 of a second day (twₚ=[18:00, 08:00]) that is a daily time window during which departing individuals are most likely to be at their origin prevalence zone zpᵢ (e.g., individuals spending the nighttime at their homes in the considered example).

For the individuals of the B category only a destination catchment area matrix, or DCA^{B} matrix 500^{B}, may be computed, since the origin of arriving individuals is generally not used in assessing the catchment area associated with the transport hub 205H under examination.

In this case, the start time Ts′ of the successive daily (time) window twₛ may be set equal to 18:00 (Ts′=18:00) of a day comprised in the successive time period T_{suc}, and the end time Te′ thereof may be set equal to 08:00 (Te′=08:00) of a following day comprised in the successive time period T_{suc}. In other words, the successive daily (time) window twₛ ranges from 18:00 of a first day to the 08:00 of a second day (twₛ=[18:00, 08:00]) that is a daily time window during which arriving individuals are most likely to be at their destination prevalence zone zpⱼ.

For the individuals of the C category both origin and destination catchment area matrices, indicated with references 400^{C} and 500^{C} in FIGS. 6 and 7, respectively, are computed, since both the origin and destination zones for outgoing commuting individuals are generally comprised within the catchment area associated with the transport hub 205H under examination.

In this case, the start time Ts of the previous daily (time) window twₚ may be set equal to 18:00 (Ts=18:00) of a day comprised in the previous time period Tₚᵣₑᵥ, and the end time Te thereof may be set equal to 08:00 (Te=08:00) of a following day comprised in the previous time period Tₚᵣₑᵥ. In other words, the previous daily (time) window twₚ ranges from 18:00 of a first day to the 08:00 of a next second day (twₚ=[18:00, 08:00]) that is a daily time window during which outgoing commuting individuals are most likely to be at their origin prevalence zone zpᵢ (e.g., individuals spending the nighttime at their homes). Similarly, the start time Ts′ of the successive daily (time) window twₛ may be set equal to 18:00 (Ts′=18:00) of a day comprised in the successive time period T_{suc}, and the end time Te′ may be set equal to 08:00 (Te′=08:00) of a following day comprised in the successive time period T_{suc}. In other words, the successive daily (time) window twₛ ranges from 18:00 of a third day to the 08:00 of a next fourth day (twₛ=[18:00, 08:00]) that is a daily time window during which outgoing commuting individuals are most likely to be at their destination prevalence zone zpⱼ (e.g., individuals have returned to their homes for spending there nighttime).

For the individuals of the D category both origin and destination catchment area matrices, indicated with references 400^{D} and 500^{D} in FIGS. 6 and 7, respectively, are computed, since both origin and destination zones for arriving commuting individuals may be generally defined within the catchment area associated with the transport hub 205H under examination.

In this case, the previous daily (time) window twₚ and the successive daily (time) window twₛ are superimposed one to the other and, particularly, the start times Ts and Ts′ are set equal to the time instant at which a first event eᵥ is detected within the hub area 205 (i.e., the individual arrives at the hub area 205 by means of a transportation vehicle), while the end times Te and Te′ are set equal to the time instant at which a last event eᵥ is detected in the hub area 205 (i.e., the individual leaves the hub area 205 by means of a transportation vehicle). It should be noted that the DCA^{D} matrix 500^{D} is the transposed matrix of the OCA^{D} matrix 400^{D}.

For the individuals of the E category both origin and destination catchment area matrices, indicated with references 400^{E} and 500^{E} in FIGS. 6 and 7, respectively, are computed, since both the origin and destination zones for non-travelling individuals are generally comprised within the catchment area associated with the transport hub 205H under examination.

In this case, the start time Ts of the previous daily (time) window twₚ may be set equal to 18:00 (Ts=18:00) of a day comprised in the previous time period Tₚᵣₑᵥ, and the end time Te thereof may be set equal to 08:00 (Te=08:00) of a following day comprised in the previous time period Tₚᵣₑᵥ. In other words, the previous daily (time) window twₚ ranges from 18:00 of a first day to the 08:00 of a second day (twₚ=[18:00, 08:00]) that is a daily time window during which non-travelling individuals are most likely to be at their origin prevalence zone zpᵢ (e.g., individuals spending the nighttime at their homes). Similarly, the start time Ts′ of the successive daily (time) window twₛ may be set equal to 18:00 (Ts′=18:00) of a day comprised in the successive time period T_{suc}, and the end time Te′ may be set equal to 08:00 (Te′=08:00) of a following day comprised in the successive time period T_{suc}. In other words, the successive daily (time) window twₛ ranges from 18:00 of a third day to the 08:00 of a fourth day (twₛ=[18:00, 08:00]) that is a daily time window during which non-travelling individuals are most likely to be at their destination prevalence zone zpⱼ (e.g., individuals having returned to their homes for spending there nighttime).

For the individuals of the F category both origin and destination catchment area matrices, indicated with references 400^{F} and 500^{F} in FIGS. 6 and 7, respectively, are computed, since both the origin and destination zones for (transport hub 205H) personnel individuals are generally comprised within the catchment area associated with the transport hub 205H under examination.

In this case, the start time Ts of the previous daily (time) window twₚ may be set equal to 18:00 (Ts=18:00) of a day comprised in the previous time period Tₚᵣₑᵥ, and the end time Te thereof may be set equal to 08:00 (Te=08:00) of a following day comprised in the previous time period Tₚᵣₑᵥ. In other words, the previous daily (time) window twₚ ranges from 18:00 of a first day to the 08:00 of a next second day (twₚ=[18:00, 08:00]) that is a daily time window during which personnel individuals are most likely to be at their origin prevalence zone zpᵢ (e.g., individuals spending the nighttime at their homes). Similarly, the start time Ts′ of the successive daily (time) window twₛ may be set equal to 18:00 (Ts′=18:00) of a day comprised in the successive time period T_{suc}, and the end time Te′ may be set equal to 08:00 (Te′=08:00) of a following day comprised in the successive time period T_{suc}. In other words, the successive daily (time) window twₛ ranges from 18:00 of a third day to the 08:00 of a fourth day (twₛ=[18:00, 08:00]) that is a daily time window during which personnel individuals are most likely to be at their destination prevalence zone zpⱼ (e.g., individuals have returned to their homes for spending there nighttime).

For the individuals of the G category both origin and destination catchment area matrices, indicated with references 400^{G} and 500^{G} in FIGS. 6 and 7, respectively, are computed, since both the origin and destination zones for other individuals (i.e., individuals not comprised in any of the preceding categories) are generally comprised within the catchment area associated with the transport hub 205H under examination.

In this case, the start time Ts of the previous daily (time) window twₚ may be set equal to 18:00 (Ts=18:00) of a day comprised in the previous time period Tₚᵣₑᵥ, and the end time Te thereof may be set equal to 08:00 (Te=08:00) of a following day comprised in the previous time period Tₚᵣₑᵥ. In other words, the previous daily (time) window twₚ ranges from 18:00 of a first day to the 08:00 of a next second day (twₚ=[18:00, 08:00]) that is a daily time window during which other individuals are most likely to be at their origin prevalence zone zpᵢ (e.g., individuals spending the nighttime at their homes). Similarly, the start time Ts′ of the successive daily (time) window twₛ may be set equal to 18:00 (Ts′=18:00) of a day comprised in the successive time period T_{suc}, and the end time Te′ may be set equal to 08:00 (Te′=08:00) of a following day comprised in the successive time period T_{suc}. In other words, the successive daily (time) window twₛ ranges from 18:00 of a third day to the 08:00 of a fourth day (twₛ=[18:00, 08:00]) that is a daily time window during which other individuals are most likely to be at their destination prevalence zone zpⱼ (e.g., individuals have returned to their homes for spending there nighttime).

Once the set 600 of OCA^{k} matrices 400^{k} and the set 700 of DCA^{k} matrices 500^{k} have been computed (e.g., as described above), it is possible to identify respective catchment area(s) for each category A to G.

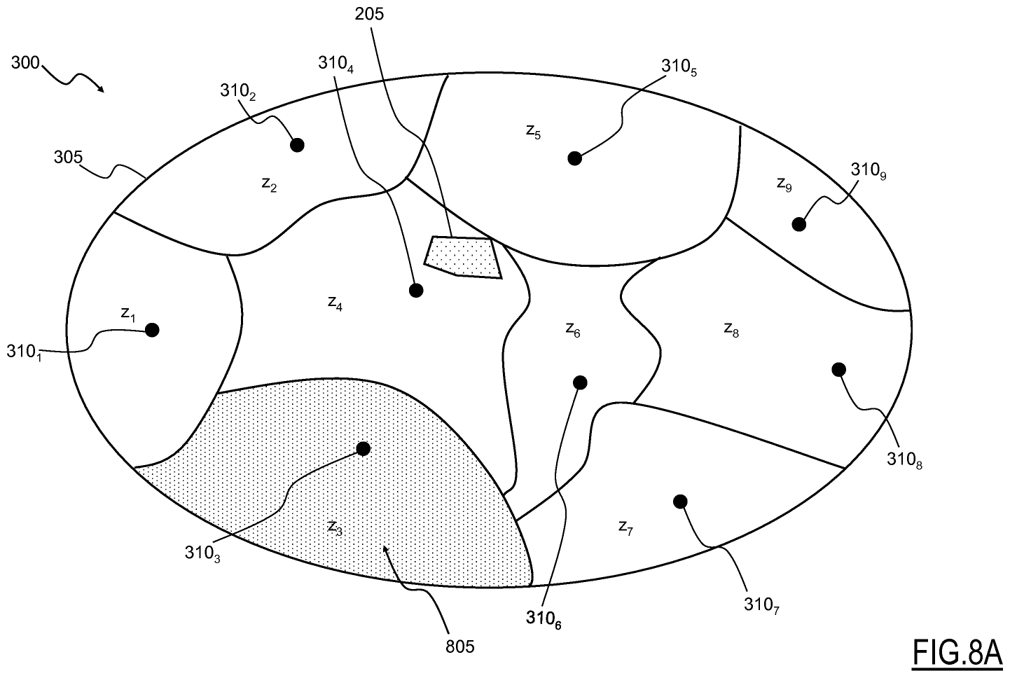

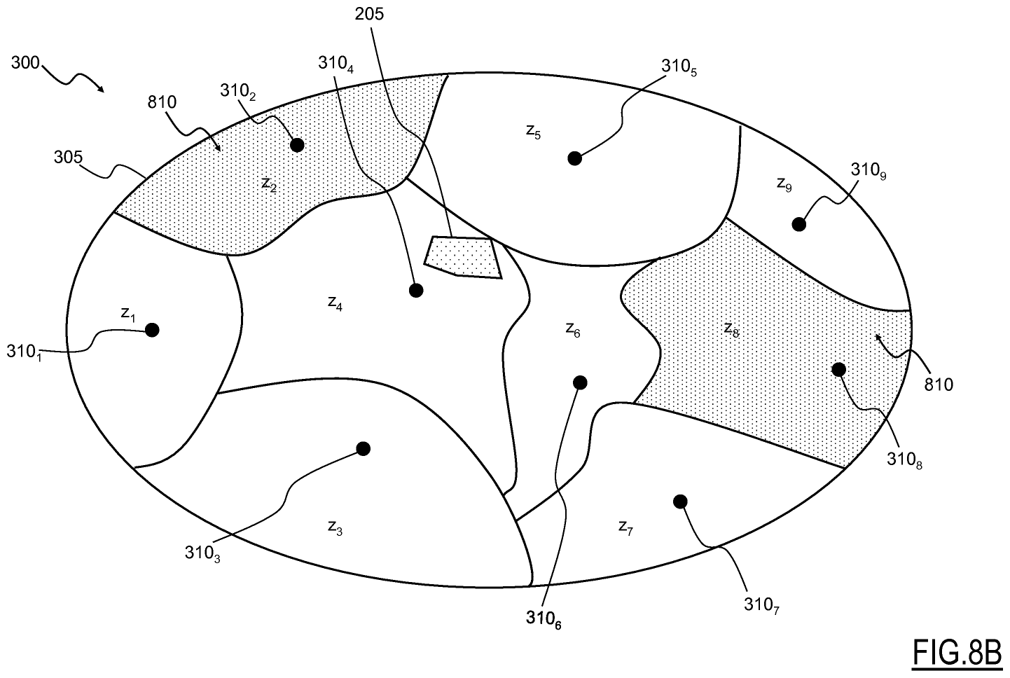

For example, FIGS. 8A and 8B are schematic representations of the Rol 300 in which a catchment area 805 for the individuals belonging to the A category, and a catchment area 810 for individuals belonging to the B category, respectively are outlined.

It should be noted that the catchment areas, such as the catchment areas 805 and 810 of the example of FIGS. 8A and 8B, may comprise one or more zones z_{q} according to a criterion exploited for identifying the catchment areas.

In a non-limiting embodiment of the invention, the catchment areas, such as the catchment area 805 of the example of FIG. 8A, may be identified as the zone z_{q}, such as for example the zone z₃ in the example of FIG. 8A, which respective element oca_{q}—i.e., oca₃ in the example of FIGS. 8A—has the greatest value among the elements ocaᵢ of the OCA^{A} matrix 400^{A}.

Alternatively, the catchment areas, such as the catchment area 810 of the example of FIG. 8B, may be identified as the one or more zones z_{q}, such as for example the zones z₂ and z₈ in the example of FIG. 8A, which respective elements oca_{q}—i.e., dca₂ and dca₈ in the example of FIGS. 8B—among the elements dcAⱼ of the DCA^{B} matrix 500^{B} that exceed a predetermined catchment threshold value (e.g., set by the administrator or by the user of the system 100).

It should be noted that other criteria of selection for the zones z_{q} may be exploited in order to define the catchment areas associated with the transport hub 205H without departing from the scope of the present invention.

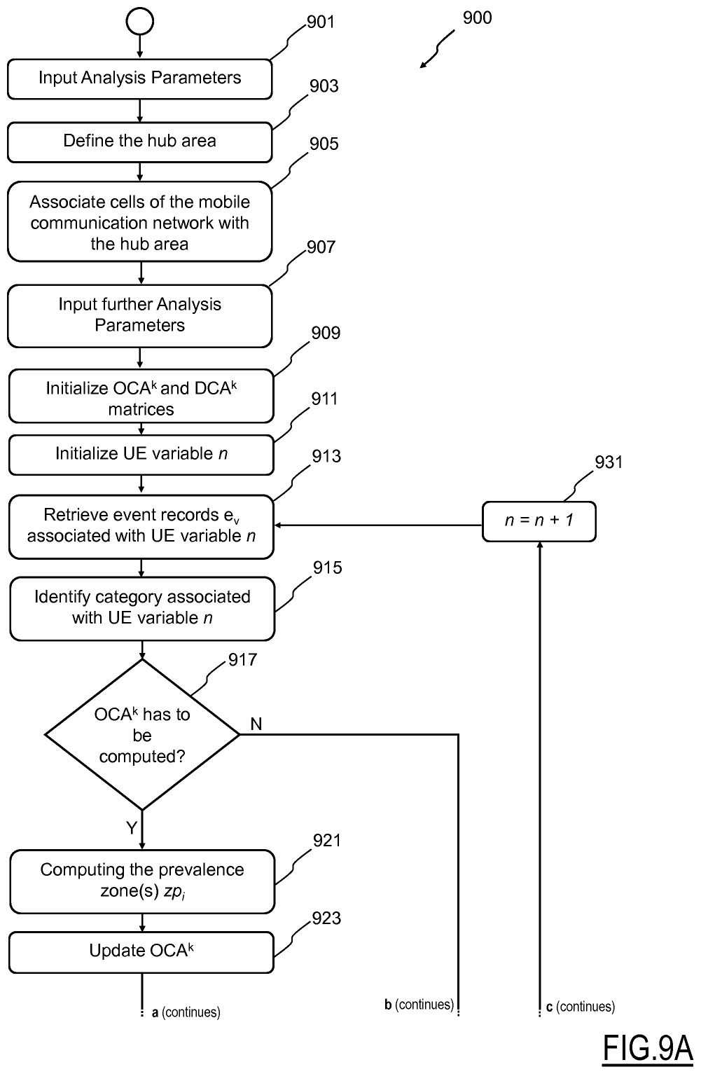

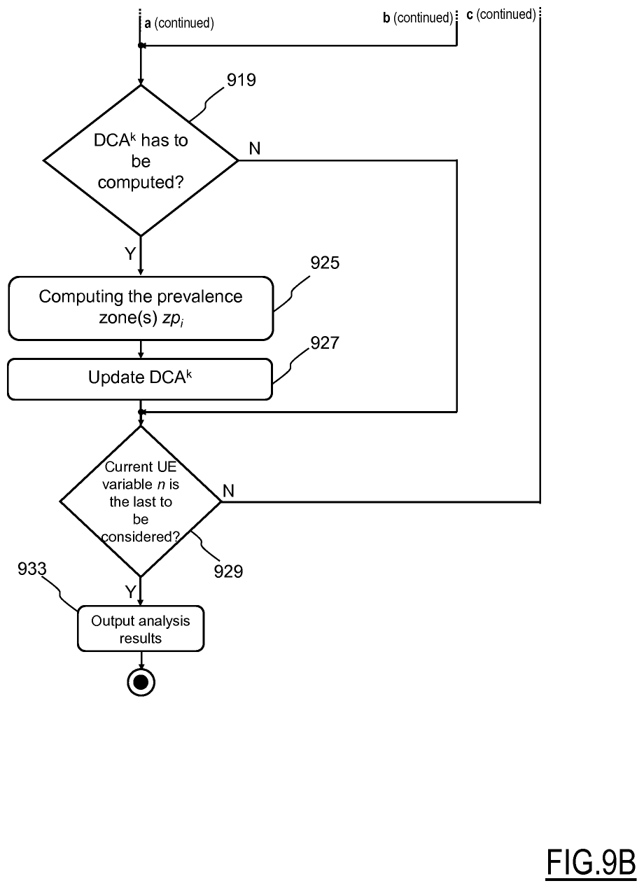

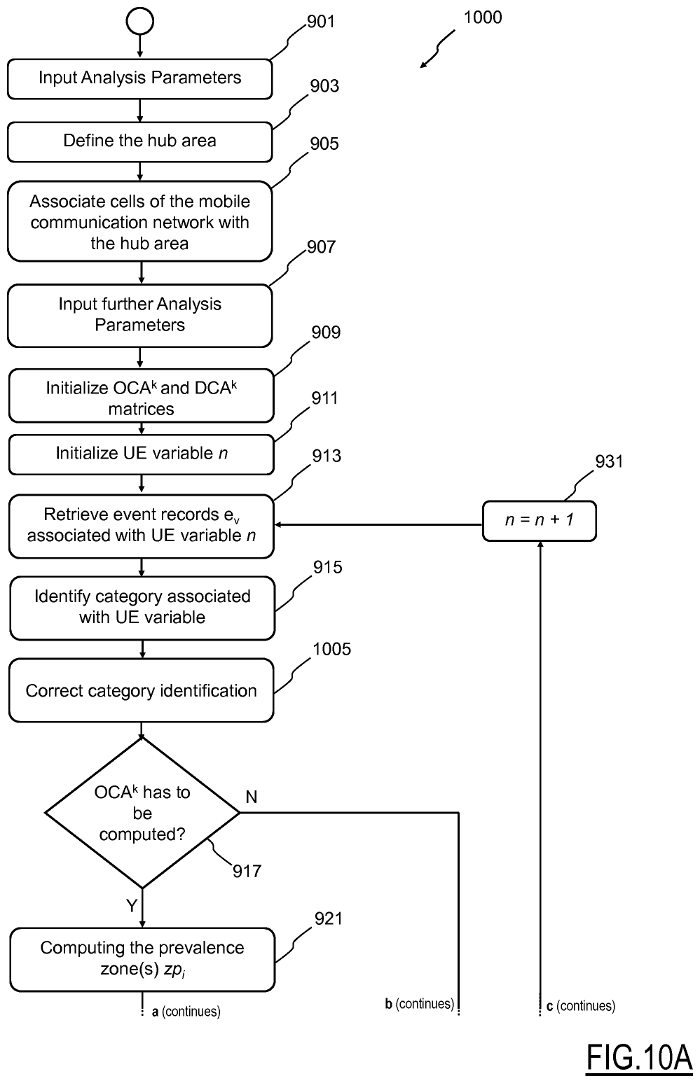

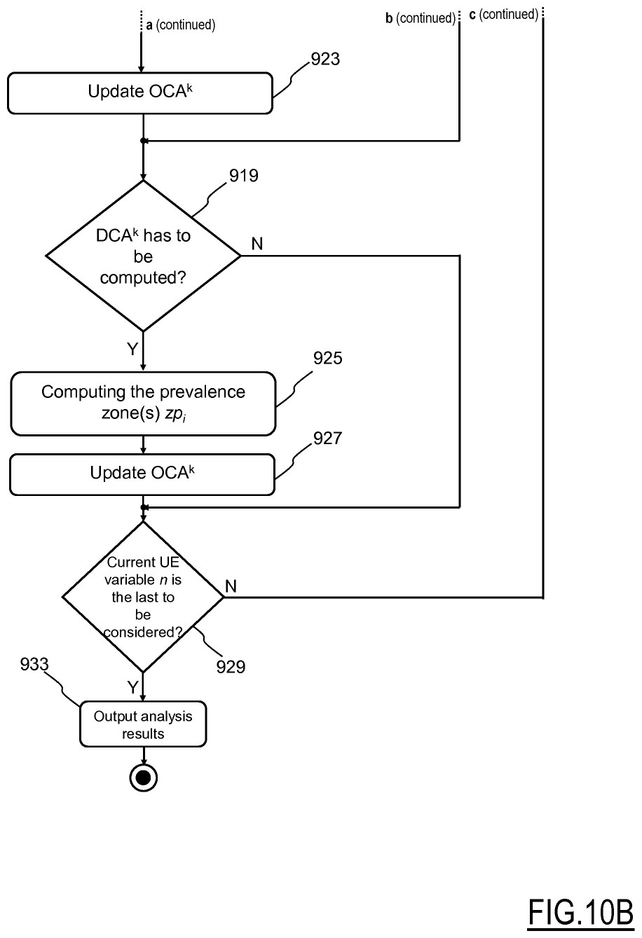

FIGS. 9A-9B show a flow chart of a process 900 for computing one or more catchment areas according to an embodiment of the present invention.

Initially (block 901), the administrator, through the administrator interface 120, and/or the user, through the user interface 125, inputs one or more parameters for defining the analysis to be performed.

For example, the parameters can comprise (in a non-limiting manner) the observation time period T_{obs} during which the movements of individuals are considered and the surveyed area 107 (comprising the transport hub 205H). Possibly, a size (in terms of a number of UEs) of the pool of UEs may be defined; alternatively, all the UEs that generated events eᵥ within the hub area 205 or a default size for the pool of UEs may be exploited.

According to an embodiment of the invention, the surveyed area 107 may be defined by a digital file such as a shapefile. A shapefile is a geospatial vector data format for Geographic Information System (GIS) software. The shapefile format can spatially describe vector features such as for example: points, lines, and polygons, representing, for example, buildings, infrastructures, relevant natural conformations such as rivers, lakes, mountains etc. In addition, each item described in the shapefile may comprise additional attributes, such as name, or physical attributes, such as for example height, size, temperatures, etc., of the item.

Next (block 903), the administrator, through the administrator interface 120, and/or the user, through the user interface 125, inputs the features of the transport hub 205H considered in the analysis. Particularly, the polygon corresponding to the hub area 205 is defined.

In an embodiment of the invention, coordinates of the vertexes of the hub area 205 may be inputted to the system 100, for example another shapefile may be provided to the system 100 in order to define the hub area 205. It should be noted that nothing prevents from defining the hub area 205 as a single point in the surveyed area 107, in this case only the coordinates of such a point are inputted to the system 100.

In a further embodiment of the invention, the system 100 comprises preconfigured values for the hub area 205; preferably, the preconfigured values for the hub area 205 are stored in the repository 115 of the system 100.

For example, in order to define the hub area 205, the repository may store the coordinates of the vertexes of the polygon that corresponds to the official borders/boundaries of the considered transport hub 205H. In alternative or in addition, the repository may store preconfigured values that comprise the coordinate of a geographic point associated with considered transport hubs 205H, preferably, the coordinates substantially correspond to the coordinates provided by reliable mapping software applications/services (e.g., Google Maps, Google Earth, OpenStreetMap, etc.) for the considered transport hubs 205H.

Advantageously, the system 100 may store (in the repository 115) a list or a database of preconfigured values describing the hub area 205 and/or surveyed areas 107 comprising one or more transport hubs 205H of one or more countries of interest, continents, up to covering the whole Earth.

Accordingly, the administrator, through the administrator interface 120, and/or the user, through the user interface 125, may select a desired hub area 205 (i.e., associated with the transport hub 205H to be analyzed) among the ones stored in the repository 115.

Once the hub area 205 has been defined, the system 100 associates (block 905) a set of one or more cells 105b of the radio communication network 105 with the hub area 205.

Given the polygon that corresponds to the hub area 205, the cells 105b of the set may be selected according to:

1. a position of communication stations 105a of the radio communication network 105 with respect to the hub area 205, or

2. a coverage of the cells 105b with respect to the hub area 205.

In the first case, all the cells 105b served by a communication station 105a positioned within the hub area 205 are comprised in the set.

In the second case, all the cells 105b (which area is) at least partly superimposed to the hub area 205 are comprised in the set. For example, the coverage of the cells 105b may be modelled by exploiting network planning software used by network providers or may be determined by exploiting antenna radiation diagrams (e.g., as described in Theodore S. Rappaport, “Wireless Communications”, Prentice Hall, 1996, Chapter 3 pages 69-138, and Chapter 4 pages 139-196). Alternatively, the coverage of the cells 105b may be modelled by means of Voronoi tessellation diagrams in which each Voronoi cell corresponds to a cell 105b of the radio communication network 105 (Voronoi tessellation diagrams are well known in the art, therefore they are not discussed further herein).

It should be noted that, selecting the cells 105b based on the coverage thereof is more comprehensive than considering the position of the communication stations 105a, since it allows considering also cells 105b having communication station 105a positioned outside the hub area 205 but able to serve UEs comprised in the hub area 205.

In case the hub area 205 has been defined as a point as mentioned above, all the cells 105b which are able to serve UEs over an area (i.e. coverage) comprising such point are associated with the hub area 205.

One or more ‘dedicated’ cells 105b (and/or dedicated WLAN access points, for example) may be deployed within the hub area 205 in order to insure/improve an availability of the telecommunication service therein (since a large number of active User Equipment is generally expected within the hub area 205). In this case, such a set of one or more dedicated cells 105b is automatically associated with the hub area 205, in addition or in alternative to the cells 105b associated with the hub area 205 by using the techniques described above. This results particularly useful when the identification of the cells 105b by means of the techniques described above requires an excessive computational effort for the system 100.

Preferably, the administrator interface 120 and, also preferably, the user interface 125 are configured for respectively allowing an administrator or a user to select, modify, delete and/or define one or more cells 105b associated with the hub area 205.

In the following, for the sake of simplicity, the hub area 205 is generally meant to comprise the geographic area delimited by the hub area 205, and the cells 105b of the mobile telecommunication network 105 associated with the hub area 205. Similarly, the surveyed area 107 may be considered both in terms of geographic area and in terms of cells 105b of the mobile telecommunication network 105 associated with the surveyed area 107 (i.e., cells 105b of the mobile telecommunication network 105 providing radio communication services within the surveyed area 107).

Afterwards (block 907) the administrator, through the administrator interface 120, and/or the user, through the user interface 125, inputs further analysis parameters that are exploited by the system 100 for identifying the catchment areas.

For example, the administrator/user defines the Rol 300, e.g. defines the external cordon 305 and the zones z_{q}. In addition, the previous time period Tₚᵣₑᵥ, the successive time period T_{suc}, and the previous and successive daily time windows twₚ and twₛ are defined.

Advantageously, one or more default sets of time periods T_{obs}, Tₚᵣₑᵥ, T_{suc}, and daily time windows twₚ and twₛ, can be provided for each category A to G (e.g., the predetermined time periods T_{obs}, Tₚᵣₑᵥ, T_{suc}, and daily time windows twₚ and twₛ described in the example above) in case no custom selection is provided by the administrator/user.

Furthermore (still at block 907), the administrator/user may select and/or define the algorithm used to identify the prevalence zones zpᵢ and zpⱼ. Also in this case, a default algorithm can be provided in case the administrator/user does not select or define any algorithm.

The set 600 of OCA^{k} matrices 400^{k} and the set 700 of DCA^{k} matrices 500^{k} are generated (block 909) based on the inputted parameters of the Rol 300, and the values of each entry of the OCA^{k} matrices 400^{k} and of DCA^{k} matrices 500^{k} are initialized to a predetermined value, preferably zero.

Still at block 907, the system 100 (in particular the computation engine 110) retrieves event records erᵥ stored in the repository 115. Preferably, the computation engine 110 retrieves one group ergₙ of event records erᵥ generated by a same UE n during the time periods T_{obs}, Tₚᵣₑᵥ, T_{suc} previously specified.

More specifically, the computation engine 110 initializes a UE variable n (e.g., n=N, N≥0; block 911) and then retrieves (block 913), e.g. sequentially, from the repository 115 a corresponding n-th event records group ergₙ therein stored for the UE currently associated with the variable n.

The event records erᵥ generated by a same UE n during the observation time period T_{obs} are analyzed (block 915) in order to find a match between a sequence of events eᵥ and an events pattern Ap, Bp, Cp, Dp, Ep₁, Ep₂, Ep₃, Fp₁, Fp₂, Fp₃, or Gp associated with a respective category A to G.

For example, each possible sequence of events eᵥ accounted for the event records erᵥ comprised in the event records group ergₙ is compared with the events patterns until a match is found.

Upon identification of a sequence of events eᵥ matching an events pattern, the category A to G to which the individual owning the n-th UE belongs is determined.

It should be noted that in case no matches are found between a sequence of events eᵥ and an events pattern Ap, Bp, Cp, Dp, Ep₁, Ep₂, Ep₃, Fp₁, Fp₂, Fp₃, the individual owning the n-th UE may be directly associated with the G category (i.e., without any further analysis of the event records erᵥ).

Once the category A-G has been determined for the individual owning the n-th UE, it is checked (decision block 917) whether such determined category A-G is associable with a corresponding OCA^{k} matrix 400^{k}.

In the negative case (exit branch N of decision block 917), i.e. an OCA^{k} matrix 400^{k} associable to the determined category A-G cannot be found, the system 100 moves on block 919.

In the affirmative case (exit branch Y of decision block 917), i.e. an OCA^{k} matrix 400^{k} is associable to the determined category A-G, the event records erᵥ generated by the same UE n during the previous time period Tₚᵣₑᵥ are analyzed (block 921) in order to identify the prevalence zone zpᵢ (or zones) among the zones z_{q} defined at block 907.

Then, the system 100 updates (block 923) the OCA^{k} matrix 400^{k}; for example, the element ocaᵢ of the OCA^{k} matrix 400^{k} corresponding to the prevalence zone zpᵢ (or zones) identified at block 921 is increased (e.g., by a value defined by the algorithm chosen at block 907).

Next, the system 100 checks (decision block 919) whether the category A-G of the individual owning the n-th UE is associable with a corresponding DCA^{k} matrix 500^{k}.

In the negative case (exit branch N of decision block 919), i.e. a DCA^{k} matrix 500^{k} is not associable to the determined category A-G, the system 100 moves on block 929.

In the affirmative case (exit branch Y of decision block 919), i.e. a DCA^{k} matrix 500^{k} is associable to the determined category A-G, the event records erᵥ generated by the same UE n during the successive time period T_{suc} are analyzed (block 925) in order to identify the prevalence zone zpⱼ (or zones) among the zones z_{q} defined at block 907 according to the chosen algorithm.

Then, the system 100 updates (block 927) the DCA^{k} matrix 500^{k}; for example, the element dca₁ (or elements) of the DCA^{k} matrix 500^{k} corresponding to the successive prevalence zone zpⱼ (or zones) identified at block 925 is increased (e.g., by a value defined by the algorithm chosen at block 907).

Afterwards, the system 100 checks (decision block 929) whether the event records group ergₙ was the last event records group to be considered (i.e., all the UEs belonging to individuals that reached the transport hub 205H during the observation time period T_{obs} has been considered).

In the negative case (exit branch N of decision block 929) the UE variable n is incremented (block 931) by one (n=n+1) and the (next) n+1-th event records group ergₙ₊₁ stored in the repository 115 is retrieved (by returning to block 913).

In the affirmative case (exit branch Y of decision block 929), i.e. each event records group ergₙ in the repository has been analyzed, the system 100 determines catchment areas and provides (block 933) the analysis results to the administrator through the administrator interface 120 and/or to the user through the User Interface 125.

Preferably, the analysis results comprise (but are not limited to) the set 600 of OCA^{k} matrices 400^{k} and the set 700 of DCA^{k} matrices 500^{k}.

Advantageously, the system 100 evaluates the catchment area(s) for each category k as the combination of zones z_{q} of the corresponding OCA^{k} matrix 400^{k} or of the corresponding DCA^{k} matrix 500^{k} respectively associated with the greatest values ocaᵢ or dcaⱼ, or alternatively which values ocaᵢ or dcaⱼ, respectively exceed a predetermined threshold (e.g., set by the administrator or by the user through the respective interfaces 120 or 125), as described above.

After such provision of the analysis results the operation of the system 100 is concluded.

It should be noted that for categories C to G two catchment areas may be computed, i.e. an origin catchment area based on the analysis of the corresponding OCA^{k} matrix 400^{k} and a destination catchment area based on the analysis of the corresponding DCA^{k} matrix 500^{k}.

This allows the user of the system 100, according to his/her needs, to freely obtain desired information about, for example, numbers and purposes of individuals reaching the transport hub 205H.

Obviously, the procedure herein described may undergo many changes and modifications without departing from the scope of the present invention.

For example, the user (or the administrator) may optionally limit the search of patterns of events eᵥ in such a way that only a subset of categories of individuals (e.g., subset of categories of individuals comprised among the categories of individuals A to G) are identified and analyzed.

Further optionally, the user (or the administrator) may introduce an operating time of the transport hub 205H, e.g. a daily time period during which the transport hub 205H is fully functional and transport means arrive and depart therefrom.

For example, the official operating time period of the transport hub 205H may be considered. Preferably, time margins can be added to the official operating time period.

In an embodiment of the invention the considered daily time period is set starting 30 minutes before a first scheduled transportation means arrival or departure (e.g., the first airplane landing at, or flying from, the transport hub 205H) and ending 30 minutes after a last scheduled transportation means arrival or departure (e.g., the last airplane landing at, or flying from, the transport hub 205H).

Time margins allows taking into account that individuals arrive at the transport hub 205H earlier than the time of the scheduled departure or may stay at the transport hub 205H beyond the scheduled time of arrival.

In this case, an individual that, during the observation time period T_{obs}, is associated with an event eᵥ recorded at a time instant outside the operating time of the transport hub 205H may be directly identified as belonging to the G category (i.e., without any further analysis).

FIGS. 10A and 10B show a flow chart for an alternative process 1000 according to an embodiment of the present invention. The alternative process 1000 differs from the process 900 previously described in what follows (wherein similar references denotes similar blocks of the processes, whose description is not herein reiterated for the sake of conciseness).

Between block 915, in which the category A-G is identified for the individual owning the n-th UE, and block 917, in which it is assessed whether or not the category A-G allows computing a respective OCA^{k} matrix 400^{k}, the process 1000 implements a category correction procedure (block 1005).

Specifically, in one embodiment of the invention, the events eᵥ of which an event record erᵥ has been recorded during the successive time period T_{suc} and/or the previous time period Tₚᵣₑᵥ are exploited for identifying faulty associations between category A-G and individuals and for correcting them.

Preferably, events eᵥ occurring during a selected portion of the successive time period T_{suc} within a predetermined time interval from the end of the observation time period T_{obs} (e.g., within a predetermined time window on a first day of the successive time period T₅ following a last day of the observation time period T_{obs}) may be used for identifying and correcting associations of individuals to a wrong category A-G.

For example, if the individual owning the n-th UE has been classified as belonging to the A category, but an event eᵥ has been detected during a (first) selected portion of the successive time portion T_{suc} and within the surveyed area 107 outside the hub area 205, such individual owning the n-th UE is considered belonging to the C category rather than to the A category.

Conversely, if the individual owning the n-th UE has been classified as belonging to the A category, but an event eᵥ has been detected during a (second) selected portion of the successive time portion T_{suc} (e.g., following the first selected portion mentioned above) and within the surveyed area 107 outside the hub area 205, such individual owning the n-th UE is considered belonging to the G category rather than to the A category.

Preferably, the first selected portion of the successive time portion T_{suc} comprises the arrival times of one or more transportation means at the transport hub 205H (e.g., the earliest time of arrival associated with a transportation means arriving at the transport hub 205H and/or the earliest time of arrival associated with transportation means travelling along more common commuting paths).

Similarly, events eᵥ occurring during a selected portion of the previous time period Tₚᵣₑᵥ within a predetermined time interval before the start of the observation time period T_{obs} (e.g., within a predetermined time window on a last day of the previous time period Tₚᵣₑᵥ preceding a first day of the observation time period T_{obs}) may be used for identifying and correcting associations of individuals to a wrong category A-G.

For example, if the individual owning the n-th UE has been classified as belonging to the B or D category, but an event eᵥ has been detected during a (first) selected portion of the previous time period Tₚᵣₑᵥ and within the surveyed area 107 outside the hub area 205, such individual owning the n-th UE is considered belonging to the C category rather than to the A category.

Alternatively, others category correction techniques may be implemented. For example, it is possible to implement a correction technique that comprise an analysis of the events eᵥ occurring during the successive time period T_{suc} (or a selected portion thereof) and/or the previous time period Tₚᵣₑᵥ (or a selected portion thereof) for the individual owning the n-th UE in order to detect an inconsistency in the assignment of the categories to such individual and to correct such inconsistency.

In an embodiment of the invention, a following further correction technique is implemented in order to detect individuals associated with a wrong category A-G.

Individuals initially classified as belonging to A category are re-classified as belonging to category G, whether during the successive time period T_{suc}, such individuals, are classified as belonging to one of the categories A, C or G. This is consistent with the fact that it is highly implausible that individuals that left the hub area 205 during the observation time period T_{obs} are able to leave the same hub area 205 again during the successive time period T_{suc}.

Individuals initially classified as belonging to B category are re-classified as belonging to category G, whether during the successive time period T_{suc}, such individuals, are classified as belonging to one of the categories B or D. This is consistent with the fact that it is highly implausible that individuals that arrived at the hub area 205 during the observation time period T_{obs} are able to arrive at the same hub area 205 again during the successive time period T_{suc}.

Individuals initially classified as belonging to A category are re-classified as belonging to category G, whether during the previous time period Tₚᵣₑᵥ, such individuals, are classified as belonging to one of the categories A, or D. This is consistent with the fact that it is highly implausible that individuals that left the hub area 205 during the previous time period Tₚᵣₑᵥ are able to leave the same hub area 205 again during the observation time period T_{obs}.

Individuals initially classified as belonging to B category are re-classified as belonging to category G, whether during the previous time period Tₚᵣₑᵥ, such individuals, are classified as belonging to one of the categories B or C. This is consistent with the fact that it is highly implausible that individuals that arrived at the hub area 205 during the previous time period Tₚᵣₑᵥ are able to arrive at the same hub area 205 again during the observation time period T_{obs}.

Alternatively or in addition, the system 100 may be configured for strictly avoid inconsistencies in the category A-G. For example, individuals initially classified as belonging to A or B category may be re-classified as belonging to category G, whether during the previous time period Tₚᵣₑᵥ or the successive time period T_{suc}, such individuals, are classified as belonging to one of the categories E, or F.

In one embodiment of the invention, the administrator of the system 100, through the administrator Interface 120 and/or the user, through the user interface 125, may define different correction policies to exploit in category correction.

Optionally, for example at block 907, the administrator of the system 100, through the administrator Interface 120 and/or the user, through the user interface 125, may select a subset of categories A-G. For example, a user may select to analyze catchment areas associated only with individuals that are working personnel of the transport hub 205H (i.e., category F) or considering only commuting individuals (both incoming and outgoing; i.e., categories C and D), according to the administrator/user interests/needs.

In this way, it is possible to reduce overall the computational effort required to the system 100 since only the OCA^{k} matrices 400^{k} and DCA^{k} matrices 500^{k} relating to the selected categories A-G are generated instead of OCA^{k} matrices 400^{k} and DCA^{k} matrices 500^{k} for all the categories A-G.

In a further embodiment of the invention, the system 100 may be configured for defining a single catchment area matrix based on the combination of data acquired during the successive time portion T_{suc} and the previous time portion Tₚᵣₑᵥ.

It should be noted that the system 100 may further be exploited to perform and combine data analysis, counting and categorizing people, referred to two or more observation time periods. Advantageously, the combination of results of data analysis referred to two or more observation time periods allows having a more complete overview of the travelling habits of individuals availing themselves of the services provided by the transport hub 205H and, thus, identifying with greater accuracy the catchment areas.

For example, it is possible to detect whether an individual that in a first observation time period is identified as to belong to A category takes a return trip to the hub area 205/surveyed area 107 by identifying such individual as belonging to B category during a successive observation time period.

In an embodiment of the invention, the previous time period Tₚᵣₑᵥ and/or successive time period T_{suc} may be exploited as additional time periods over which the system 100 may be configured to perform data analysis for having a more complete overview of the travelling habits of individuals. For example, in case an individual is classified as belonging to the A category in a first observation time period and classified as belonging to the B category in a (next) second observation time period, a OCA^{A} matrix 400^{A} may be computed based on event records erᵥ recorded during the previous time period Tₚᵣₑᵥ and a DCA^{B} matrix 500⁸ may be computed based on event records erᵥ recorded during the successive time period T_{suc}.

Moreover, it is possible to identify sub-categories of individuals, such as for example frequent travelers, i.e. individuals that are identified as belonging to categories A and B, C or D during a predetermined number of considered observation time periods.

In an embodiment of the invention, a plurality of OCA^{k} matrices 400^{k} and/or DCA^{k} matrices 500^{k} may be computed over respective previous time period Tₚᵣₑᵥ and/or successive time period T_{suc} for each observation time period T_{obs} of the predetermined number of considered observation time periods. The OCA^{k} matrices 400^{k} and/or DCA^{k} matrices 500^{k} so obtained are preferably exploited for providing corresponding one or more averaged OCA^{k} matrices 400^{k} and/or DCA^{k} matrices 500^{k}.

Further additionally or alternatively, it is possible to define sub-categories that comprise one or more events recorded at one or more predetermined locations, or Points of in Interest—Pol, in addition to the hub area 205, such as for example buildings (historical buildings, museums, government buildings, etc.), city squares, parks and/or other transport hubs comprised within the surveyed area 107.

Advantageously, the Pol may be defined—by the administrator or by the user of the system 100—as a point or as an area of the surveyed area 107, which may be associated with one or more cells 105b of the mobile telecommunication network 105 similarly as above described with respect to the hub area 205.

In this case, DCA^{k} matrices 500^{k} and/or OCA^{k} matrices 400^{k} comprising the Pol would be highlighted by the analysis and Pol catchment areas comprising the Pol would be particularly (although not exclusively) considered for assessing individuals exploiting the transport hub 205H for reaching or leaving the Pol.

Further optionally, the system administrator (through the administrator interface 120) and, possibly, the user (through the user interface 125) may define new categories of individuals, or may define sub-categories for the preset categories A to G (obviously, one or more different events patterns are associated with each sub-category).

For example, the G category may be divided into two sub-categories: a first sub-category, e.g. G1, that comprises events patterns including one or more events eᵥ detected in the surveyed area 107, but none in the hub area 205 (i.e., individuals that do not reach the transport hub 205H). Conversely, a second sub-category, e.g. G2, may comprise events patterns including one or more events eᵥ in the hub area 205 (i.e., effectively un-categorized individuals that reached/leaved the transport hub 205H).

It should be noted that the system 100 might be adapted to retrieve (or receive) data about individuals not exclusively from a mobile telephony network 105. Alternatively or in addition, the system may be configured to retrieve (or receive) data about individuals from one or more wireless networks, such as WLANs, operating in the surveyed area 107, provided that the UE of the individuals are able to connect to such wireless communication networks.

1. A method of evaluating at least one catchment area of a transport hub, wherein said transport hub is comprised in a hub area which is covered by a mobile telecommunication network having a plurality of communication stations each of which is adapted to manage communications of User Equipment owned by individuals in one or more respective served areas comprised in at least one geographic area over which the mobile telecommunication network provides services, the mobile telecommunication network being configured for storing event records each one indicating at least a time instant (ts) and a position (ps) of each event of interaction between a User Equipment and a communication station of the mobile telecommunication network, the method comprising:
defining two or more categories (A, B, C, D, E, F, G) of individuals based on a purpose for which the individuals reach or leave the transport hub;
for each category, defining at least an associated events pattern (Ap, Bp, Cp, Dp, Ep1, Ep2, Ep3, Fp1, Fp2, Fp3, Gp), the events pattern being a sequence of events of interaction between a User Equipment and a communication station of the mobile telecommunication network;
subdividing the at least one geographic area into at least two zones (zq);
acquiring event records from the mobile telecommunication network associated with User Equipment,
for a User Equipment of a pool of User Equipment:
searching the event records related to said User Equipment for identifying a sequence of events matching an events pattern associated with a category;
upon finding a match, associating the owner of the User Equipment with the corresponding category;
searching the event records related to said User Equipment for identifying at least one prevalence zone (zpi, zpj) of the at least two zones prevalently visited by the owner of the User Equipment, and
evaluating the at least one catchment area based on the category and on the prevalence zone identified for each User Equipment of the pool.

2. The method according to claim 1, wherein searching the event records related to said User Equipment for identifying a sequence of events matching an events pattern associated with a category comprises:
searching event records indicating a respective time instant comprised within a predetermined observation period (Tobs), and
wherein searching the event records related to said User Equipment for identifying at least one prevalence zone of the at least two zones prevalently visited by the owner of the User Equipment comprises:
searching the event records recorded during a time period (Tprev, Tsuc) preceding and/or following the observation time period.

3. The method according to claim 2, wherein the time period preceding and/or following the observation time period comprise a plurality of time windows (tw).

4. The method according to claim 2, wherein searching the event records related to said User Equipment for identifying at least one prevalence zone of the at least two zones of the at least one geographic area prevalently visited by the owner of the User Equipment further comprises:
identifying as the prevalence zone a zone of the at least two zones associated with the greatest number of event records indicating a position comprised within said zone.

5. The method according to claim 2, wherein searching the event records related to said User Equipment for identifying at least one prevalence zone of the at least two zones of the at least one geographic area prevalently visited by the owner of the User Equipment further comprises:
identifying as the prevalence zone each zone of the at least two zones associated with at least one predetermined threshold number of event records indicating a position comprised within said zone.

6. The method according to claim 1, wherein evaluating the at least one catchment area based on the category and on the prevalence zone identified for each User Equipment of the pool comprises:
identifying as the catchment area the zone of the at least two zones which is identified as the prevalence zone for the greatest number of owners of User Equipment.

7. The method according to claim 1, wherein evaluating the at least one catchment area based on the category and on the prevalence zone identified for each User Equipment of the pool comprises:
identifying as the catchment area each zone of the at least two zones which is identified as the prevalence zone for a number of owners of User Equipment equal to, or greater than, a predetermined catchment threshold number of owners of User Equipment.

8. The method according to claim 1, wherein evaluating the at least one catchment area based on the category and on the prevalence zone identified for each User Equipment of the pool comprises:
identifying a respective catchment area for each category associated with at least one owner of the User Equipment of the pool of User Equipment.

9. The method according to claim 2, wherein evaluating the at least one catchment area based on the category and on the prevalence zone identified for each User Equipment of the pool further comprises:
identifying an origin catchment area based on the prevalence zone identified by searching event records recorded during the time period (Tprev) preceding the observation time period, the origin catchment area indicating an area from which owners of User Equipment reach the transport hub.

10. The method according to claim 2, wherein evaluating the at least one catchment area based on the category and on the prevalence zone identified for each User Equipment of the pool further comprises:
identifying a destination catchment area based on the prevalence zone identified by searching event records recorded during the time period (Tsuc) following the observation time period, the destination catchment indicating an area towards which owners of User Equipment leave the transport hub.

11. The method according to claim 2, further comprising:
for a User Equipment of a pool of User Equipment:
searching the event records related to said User Equipment for identifying a sequence of events matching an events pattern associated with a category during the time period (Tprev) preceding and/or the time period (Tsuc) following the observation time period;
upon finding a match, associating the owner of the User Equipment with a further corresponding category;
comparing the category and the further category associated with the owner of the User Equipment, and
assessing whether the category associated with the owner of the User Equipment has to be changed based on such comparing.

12. The method according to claim 11, wherein defining two or more categories of individuals based on a purpose for which the individuals reach or leave the transport hub comprises:
defining at least one among:
a category (A) of departing individuals, departing individuals leaving the hub area;
a category (B) of arriving individuals, arriving individuals reaching the hub area;
a category (C) of outgoing commuting individuals, outgoing commuting individuals leaving the hub area and then returning back to the hub area, and
a category (D) of incoming commuting individuals, incoming commuting individuals reaching the hub area and then leaving the hub area.

13. The method according to claim 12, wherein assessing whether the category associated with the owner of the User Equipment has to be changed based on such comparing comprises:
if the category associated with the owner of the User Equipment corresponds to the category of departing individuals during the observation time period, and the further category associated with the owner of the User Equipment corresponds to the category of arriving individuals during the time period following the observation time period, changing the category associated with the owner of the User Equipment to the category of outgoing commuting individuals, or
if the category associated with the owner of the User Equipment corresponds to the category of departing individuals during the observation time period, and the further category associated with the owner of the User Equipment corresponds to the category of arriving individuals during the time period preceding the observation time period, changing the category associated with the owner of the User Equipment to the category of incoming commuting individuals, or
if the category associated with the owner of the User Equipment corresponds to the category of arriving individuals during the observation time period, and the further category associated with the owner of the User Equipment corresponds to the category of departing individuals during the time period preceding the observation time period, changing the category associated with the owner of the User Equipment to the category of incoming commuting individuals, or
if the category associated with the owner of the User Equipment corresponds to the category of arriving individuals during the observation time period, and the further category associated with the owner of the User Equipment corresponds to the category of departing individuals during the time period following the observation time period, changing the category associated with the owner of the User Equipment to the category of outgoing commuting individuals.

14. The method according to claim 1, further comprising:
defining a selected portion of the geographic area other than the hub area as a point of interest;
wherein evaluating the at least one catchment area based on the category and on the prevalence zone identified for each User Equipment of the pool comprises:
identifying whether the at least one prevalence zone comprises the point of interest.

15. A system coupled with a mobile telecommunication network for evaluating at least one catchment area of a transport hub, the system comprising:
a computation engine adapted to process data retrieved from the mobile telecommunication network;
a repository adapted to store data regarding interactions between a User Equipment and the mobile telecommunication network, computation results generated by the computation engine and, possibly, any processing data generated by and/or provided to the system;
an administrator interface operable for modifying parameters and/or algorithms used by the computation engine and/or accessing data stored in the repository, and
a memory element storing a software program product configured for implementing the method of claim 1.
